(19) United States
(12) Patent Application Publication
(10) Pub. No.: US 2026/0316446 A1
(43) Pub. Date: Oct. 15, 2026

(54) PRINTING ELEMENT SUBSTRATE

(71) Applicant: CANON KABUSHIKI KAISHA, Tokyo (JP)

(72) Inventor: TOSHIO NEGISHI, Kanagawa (JP)

(21) Appl. No.: 19/569,608

(22) Filed: Mar. 17, 2026

(30) Foreign Application Priority Data
Apr. 9, 2025 (JP) 2025-064371

(51) Int. Cl. B41J 2/14; B41J 2/045; B41J 2/17; B41J 2/175; B41J 2/18

(52) U.S. Cl. CPC B41J 2/14072; B41J 2/04548; B41J 2/0458; B41J 2/1707; B41J 2/175; B41J 2/18; B41J 2002/14491

(57) ABSTRACT

A printing element substrate includes: a first heating resistance element row being arranged in one row; a second heating resistance element row being arranged in one row in parallel to the first heating resistance element row, a first driving element row being arranged in one row in order to drive the plurality of first heating resistance elements, the plurality of driving elements being arranged in order to drive the plurality of heating resistance elements; and a second driving element row being arranged in one row in order to drive the plurality of second heating resistance elements, in parallel to the first driving element row, the plurality of second driving elements being different from the plurality of the first driving elements. Respective distances between centers of gravity of the first and second driving elements are smaller than respective distances between centers of gravity of the first and second heating resistance elements.

### BACKGROUND

### Field of the Technology

The present disclosure relates to an arrangement technique of a driving element in a printing element substrate.

### Description of the Related Art

Conventionally, a circulation type liquid ejection apparatus configured to circulate an ink in a liquid ejection head has been known. As the circulation type liquid ejection apparatus, Japanese Patent Laid-Open No. 2020-104493 (hereinafter, referred to as PTL 1) discloses a configuration in which an ejection energy generation element configured to eject an ink and a circulation energy generation element configured to circulate an ink are provided. Additionally, a driving element is used to drive each of the ejection energy generation element and the circulation energy generation element.

### SUMMARY

An object of the present disclosure is to make it possible to properly arrange a driving element in a printing element substrate.

A printing element substrate according to an aspect of the present disclosure includes: a first heating resistance element row including a plurality of first heating resistance elements, out of a plurality of heating resistance elements, being arranged in one row; a second heating resistance element row including a plurality of second heating resistance elements, out of the plurality of heating resistance elements, being arranged in one row in parallel to the first heating resistance element row, the plurality of second heating resistance elements being different from the plurality of first heating resistance elements; a first driving element row including a plurality of first driving elements, out of a plurality of driving elements, being arranged in one row in order to drive the plurality of first heating resistance elements, the plurality of driving elements being arranged in order to drive the plurality of heating resistance elements; and a second driving element row including a plurality of second driving elements, out of the plurality of driving elements, being arranged in one row in order to drive the plurality of second heating resistance elements, in parallel to the first driving element row, the plurality of second driving elements being different from the plurality of the first driving elements, wherein a distance between centers of gravity of the two adjacent first driving elements, which are out of the respective plurality of first driving elements, is smaller than a distance between centers of gravity of the two adjacent first heating resistance elements, which are out of the respective plurality of first heating resistance elements, and a distance between the centers of gravity of the two adjacent second driving elements, which are out of the respective plurality of second driving elements, is smaller than a distance between the centers of gravity of the two adjacent second heating resistance elements, which are out of the respective plurality of second heating resistance elements.

Features of the present disclosure will become apparent from the following description of embodiments with reference to the attached drawings. The following description of embodiments is described by way of example.

### BRIEF DESCRIPTION OF THE DRAWINGS

FIG. 1A is a perspective view schematically illustrating a liquid ejection apparatus in which an ink tank as a liquid reservoir is provided outside a liquid ejection head, and FIG. 1B is a perspective view schematically illustrating the liquid ejection apparatus in which an ink sub tank is provided directly on top of the liquid ejection head.

FIG. 2A is an exploded perspective view of the liquid ejection head in each of FIGS. 1A and 1B, FIG. 2B is a diagram illustrating a case where the number of colors that can be ejected by one liquid ejection chip is four colors, FIG. 2C is a diagram illustrating a case where the number of colors that can be ejected by one liquid ejection chip is two colors, and FIG. 2D is a diagram illustrating a case where the number of colors that can be ejected by one liquid ejection chip is one color.

FIG. 3A is a plan view that is viewed from a direction in which a liquid droplet is ejected from an ejection orifice of an individual ejection unit, FIG. 3B is a IIIB-IIIB cross-sectional view of FIG. 3A, FIG. 3C is a IIIB-IIIB' cross-sectional view of FIG. 3A and is a cross-sectional view in which a configuration of the inside of a substrate is different from that in FIG. 3B, and FIG. 3D is a diagram describing flow-in of the ink in a case where a first energy generation element is driven.

FIG. 4A is a IIIB-IIIB cross-sectional view of the individual ejection unit of FIG. 3A and is a cross-sectional view describing a generation and growing process of an air bubble B generated by heating the ink with a second energy generation element and causing film boiling of the ink, FIG. 4B is a IIIB-IIIB' cross-sectional view of the individual ejection unit of FIG. 3A and is a cross-sectional view describing a contraction process of the air bubble B generated by heating the ink with the second energy generation element and causing film boiling of the ink, and FIG. 4C is a IIIB-IIIB' cross-sectional view of the individual ejection unit of FIG. 3A and is a cross-sectional view describing a process after bubble disappearance of the air bubble B generated by heating the ink with the second energy generation element and causing film boiling of the ink.

FIG. 5A is a diagram illustrating a state in which a circulatory flow of the ink is temporarily halted, FIG. 5B is a diagram illustrating a state immediately after the circulatory flow of the ink is generated by driving the second energy generation element after the state in FIG. 5A, FIG. 5C is a diagram illustrating a state in which the circulatory flow of the ink is temporarily halted after the state in FIG. 5B, and FIG. 5D is a diagram illustrating a state immediately after the circulatory flow of the ink is generated by driving the second energy generation element after the state in FIG. 5C.

FIG. 6A is a diagram illustrating a state in which the circulatory flow of the ink is temporarily halted, FIG. 6B is a diagram illustrating a state immediately after the circulatory flow of the ink is generated by driving the second energy generation element after the state in FIG. 6A, FIG. 6C is a diagram illustrating a state in which the circulatory flow of the ink is temporarily halted after the state in FIG. 6B, and FIG. 6D is a diagram illustrating a state immediately after the circulatory flow of the ink is generated by driving the second energy generation element after the state in FIG. 6C.

FIG. 7A is a plan view that is viewed from the direction in which the liquid droplet is ejected from the ejection orifice, FIG. 7B is a VIIB-VIIB cross-sectional view of FIG. 7A, and FIG. 7C is an enlarged schematic view of an individual flow path in FIG. 7A.

FIG. 8A is a plan view that is viewed from the direction in which the liquid droplet is ejected from the ejection orifice, FIG. 8B is a VIIIB-VIIIB cross-sectional view of FIG. 8A, and FIG. 8C is a VIIIB-VIIIB cross-sectional view of FIG. 8A and is a cross-sectional view in which the configuration of the inside of the substrate is different from that in FIG. 8B.

FIG. 9A is a plan view that is viewed from the direction in which the liquid droplet is ejected from the ejection orifice, FIG. 9B is a IXB-IXB cross-sectional view of FIG. 9A, and FIG. 9C is a IXB-IXB cross-sectional view of FIG. 9A and is a cross-sectional view in which the configuration of the inside of the substrate is different from that in FIG. 9B.

FIG. 10 is a diagram illustrating a circuit configuration example of a printing element substrate according to the present embodiment.

FIG. 11 is a diagram illustrating an arrangement example of a heater and a driving element in a first case according to the present embodiment.

FIG. 12 is a diagram illustrating an arrangement example of the heater and the driving element in a second case according to the present embodiment.

FIG. 13 is a diagram illustrating an arrangement example of the heater and the driving element in a third case according to the present embodiment.

FIG. 14 is a diagram illustrating an arrangement example of the heater and the driving element in a fourth case according to the present embodiment.

FIG. 15 is a diagram illustrating an arrangement example of the heater and the driving element in a first comparative example.

FIG. 16 is a diagram illustrating an arrangement example of the heater and the driving element in a second comparative example.

FIG. 17 is a diagram illustrating an enlarged example of the driving element in the first case.

FIG. 18 is a diagram illustrating an enlarged example of the driving element with fewer ground lines than that in FIG. 17.

FIG. 19 is a diagram illustrating an enlarged example of the driving element in the second case.

FIG. 20 is a diagram illustrating an enlarged example of the driving element with fewer ground lines than that in FIG. 19.

FIG. 21 is a diagram illustrating an enlarged example of the driving element in the second comparative example.

FIG. 22 is a diagram illustrating a cross section structure taken along a XXII-XXII line in FIGS. 17-20.

FIG. 23 is a diagram illustrating another circuit configuration example of the printing element substrate according to the present embodiment.

### DESCRIPTION OF THE EMBODIMENTS

Preferred embodiments of the present disclosure are described below in detail with reference to the appended drawings. Note that, the following embodiments are not intended to limit the matters of the present disclosure, and not all the combinations of the characteristics described in the following embodiments are necessarily required for the means for solving the problems of the present disclosure. Note that, the same constituent elements are denoted by the same reference numerals.

### OVERVIEW

Conventionally, a liquid ejection head has a function of circulating an ink to discharge an air bubble in a flow path of an ink and suppress thickening of an ink in the vicinity of an ejection orifice. A liquid ejection apparatus provided with the liquid ejection head having the function as described above has been known as a circulation type liquid ejection apparatus. Additionally, a method of using a pressure difference (hereinafter, also referred to as a differential pressure method) has been well known to circulate an ink. In the differential pressure method, a pressure adjustment mechanism is used to increase a pressure in the ejection orifice on an ink supply side (in-side) compared to that on an ink collection side (out-side). In this manner, an ink is allowed to flow from the in-side to the out-side. Additionally, in order to circulate an ink, it is preferable to return the ink that flows to the out-side to the in-side. Therefore, a pump is provided. Note that, there is a configuration in which the pump is provided outside the liquid ejection head of a liquid ejection apparatus main body so as to circulate the ink between the liquid ejection head and the liquid ejection apparatus main body. Alternatively, there is also a configuration in which the pump is provided inside the liquid ejection head so as to circulate the ink within the liquid ejection head. However, in the differential pressure method, since the pressure adjustment mechanism and the pump are provided, the liquid ejection apparatus main body and the liquid ejection head are likely to be large.

Therefore, the circulation of the ink with a method other than the differential pressure method has also been considered. Specifically, there is a configuration in which a circulation flow path communicating with the ejection orifice is provided, and an energy generation element (hereinafter, also referred to as a circulation energy generation element) that is different from an energy generation element configured to eject an ink (hereinafter, also referred to as an ejection energy generation element) is provided in the circulation flow path. With this configuration, it is possible to circulate the ink in the circulation flow path by driving the circulation energy generation element.

Incidentally, a configuration in which a row of the ejection energy generation elements and a row of the circulation energy generation elements are arranged in parallel to each other has been known. With this configuration, a pair of the circulation energy generation elements is mounted for the ejection energy generation element. Therefore, a driving element and a ground wiring are manufactured so as to be electrically connected to each of the ejection energy generation element and the circulation energy generation element. That is, the driving element for each of the ejection energy generation element and the circulation energy generation element is provided to a printing element substrate, and according to the consideration by the inventors and the like, there has been a case where the driving element cannot be properly arranged in the printing element substrate. Additionally, in a case where the printing element substrate is formed by an inexpensive manufacturing process, it is not preferable to provide an electric connection wiring layer as yet another layer in addition to a conductive layer to extract an electrode of the driving element. That is, it is preferable in the inexpensive manufacturing process to form the conductive layer and the wiring layer from the same layer and form in the same manufacturing step. Moreover, in a case where the magnitude of a driving current of the ejection driving element and that of a circulation driving element are different from each other among the driving elements, the driving elements being arrayed as the driving elements having the same shape, that is, having the same current driving capability in one row obtain the excessive quality, and thus it is not preferable. Specifically, in a case where the circulation driving element and the ejection driving element are formed in the same size although the driving current of the circulation driving element is smaller than the driving current of the ejection driving element, due to the excessive element size of the circulation driving element, a printing element substrate area is enlarged, and the cost may be high.

Therefore, the printing element substrate of the present disclosure includes a first heating resistance element row, a second heating resistance element row, a first driving element row, and a second driving element row. In the first heating resistance element row, multiple first heating resistance elements, out of multiple heating resistance elements, are arranged in one row. The second heating resistance element row is arranged in parallel to the first heating resistance element row, and multiple second heating resistance elements different from the multiple first heating resistance elements, out of the multiple heating resistance elements, are arranged in one row. In the first driving element row, multiple first driving elements, out of multiple driving elements arranged to drive the multiple heating resistance elements, are arranged in one row to drive the multiple first heating resistance elements. The second driving element row is arranged in parallel to the first driving element row, and multiple second driving elements different from the multiple first driving elements, out of the multiple driving elements, are arranged in one row to drive the multiple second heating resistance elements. A distance between the centers of gravity of the two adjacent first driving elements, which are out of the respective multiple first driving elements, is smaller than a distance between the centers of gravity of the two adjacent first heating resistance elements, which are out of the respective multiple first heating resistance elements. In addition, a distance between the centers of gravity of the two adjacent second driving elements, which are out of the respective multiple second driving elements, is smaller than a distance between the centers of gravity of the two adjacent second heating resistance elements, which are out of the respective multiple second heating resistance elements. According to the above-described configuration, since an excess space is generated between the driving elements, it is possible to arrange wiring between the driving elements by utilizing the excess space, for example. Thus, according to the printing element substrate of the present disclosure, it is possible to properly arrange the driving element on the printing element substrate.

Specifically, two driving element rows of different element sizes are arranged in parallel to each other in two rows, and in each row, units of the driving elements are arranged adjacent to each other, each unit including two or more driving elements adjacent to each other. It is possible to arrange each of the ground wiring and the electric connection wiring in a region generated between the units of the driving elements. Thus, it is possible to wire the conductive layer and the wiring layer in the driving element on the same layer.

### Liquid Ejection Apparatus 50

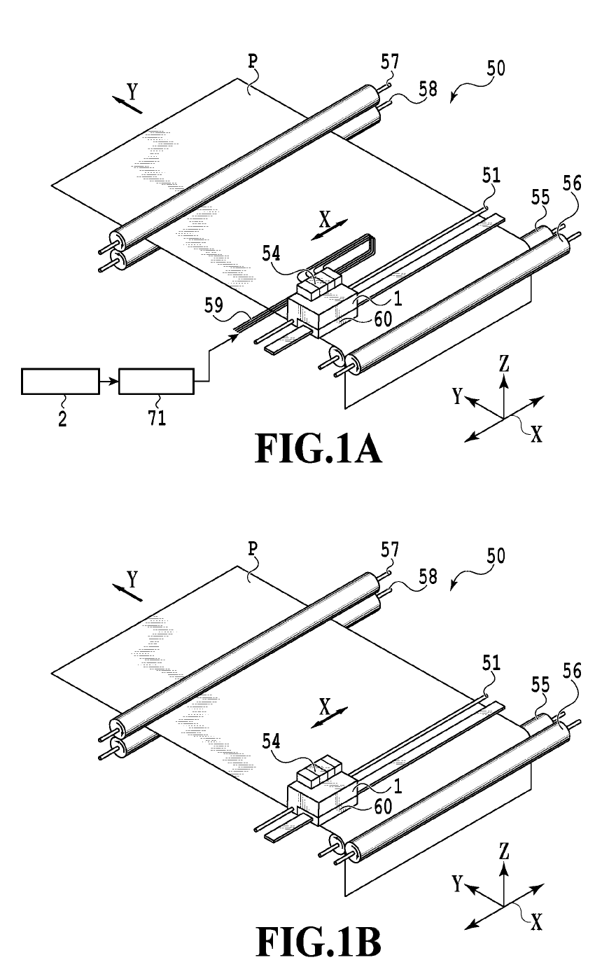

FIG. 1 is a diagram illustrating an overall configuration example of a liquid ejection apparatus 50. FIG. 1A is a perspective view schematically illustrating the liquid ejection apparatus 50 in which an ink tank 2 as a liquid reservoir is provided outside a liquid ejection head 1. FIG. 1B is a perspective view schematically illustrating the liquid ejection apparatus 50 in which an ink sub tank 54 is provided directly on top of the liquid ejection head 1. First, a common portion between FIGS. 1A and 1B is described.

The liquid ejection apparatus 50 includes the liquid ejection head 1 and conveyance rollers 55, 56, 57, and 58. The liquid ejection head 1 can scan in a direction X crossing a conveyance direction Y of an ejection target medium P. The liquid ejection head 1 is mounted on a carriage 60. The liquid ejection head 1 is fixed and supported on the carriage 60 by a not-illustrated positioning unit and an electric contact provided to the carriage 60. The carriage 60 is reciprocally moved in a main scanning direction (also referred to as the direction X) along a guide shaft 51. Therefore, the liquid ejection head 1 performs printing on the ejection target medium P by ejecting the ink while moving with the carriage 60 in the main scanning direction. The conveyance rollers 55, 56, 57, and 58 convey the ejection target medium P in a sub scanning direction (also referred to as the conveyance direction Y) crossing (in the present embodiment, orthogonal to) the main scanning direction. That is, the liquid ejection apparatus 50 forms a serial type ink jet liquid ejection apparatus by ejecting a liquid from the liquid ejection head 1 onto the ejection target medium P conveyed in the conveyance direction Y while scanning the liquid ejection head 1 in the direction X. Note that, application of the present disclosure is not limited to the serial type ink jet liquid ejection apparatus. The present disclosure is also applicable to a pagewide type ink jet liquid ejection apparatus that ejects the liquid onto the ejection target medium P conveyed in the conveyance direction Y by using a line head (pagewide type head) that is long in a page width direction of the ejection target medium P. Note that, in FIGS. 1A and 1B, a direction Z indicates a vertical direction. That is, the direction Z is a direction crossing (in the present embodiment, orthogonal to) an X-Y plane identified by the direction X and the conveyance direction Y.

The liquid ejection head 1 can eject four types of inks, which are black (K), cyan (C), magenta (M), and yellow (Y). The liquid ejection head 1 can eject a full-color image by the four types of inks. Note that, the ink that can be ejected from the liquid ejection head 1 is not limited to the above-described four types of inks. For example, the present disclosure is also applicable to the liquid ejection head 1 that ejects another type of ink such as a particular color ink. That is, the type and the number of the inks ejected from the liquid ejection head 1 are not limited.

Next, a different portion between FIGS. 1A and 1B is described. In FIG. 1A, the ink sub tank 54 is mounted on the liquid ejection head 1. Four ink supply tubes (liquid communication paths) 59 are attached to the ink sub tank 54. Additionally, the liquid ejection apparatus 50 includes the ink tank 2 and an external pump 71. The ink tank 2 reserves the ink. The ink reserved in the ink tank 2 is supplied to the ink sub tank 54 via the four ink supply tubes 59 by driving force of the external pump 71. On the other hand, in FIG. 1B, the ink sub tank 54 is provided directly on top of the liquid ejection head 1. In FIG. 1B, a different point from FIG. 1A is that, since the ink tank 2 is not provided outside the liquid ejection head 1, no four ink supply tubes 59 are attached, and no external pump 71 is provided. Note that, in either of FIGS. 1A and 1B, the liquid ejection head 1 may be provided integrally with the ink sub tank 54 and may be formed to be detachable from or attachable to the carriage 60. Alternatively, the ink sub tank 54 may be provided integrally with the carriage 60, and only the ink sub tank 54 may be formed to be detachable or attachable. In the following descriptions, the descriptions are provided using the configuration in FIG. 1A.

### Basic Configuration of Liquid Ejection Head 1

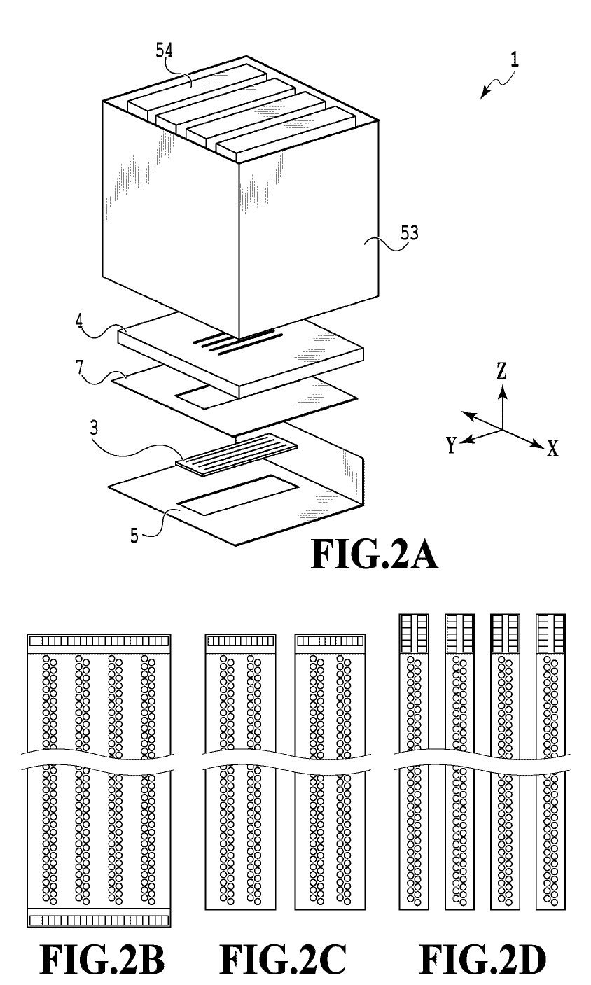

FIG. 2 is a diagram illustrating a basic configuration example of the liquid ejection head 1 in FIG. 1. FIG. 2A is an exploded perspective view of the liquid ejection head 1 in FIG. 1. FIGS. 2B, 2C, and 2D are diagrams illustrating examples of a liquid ejection chip 3 in FIG. 2A. The liquid ejection head 1 includes a storage portion 53, the ink sub tank 54, and the liquid ejection chip 3. The ink sub tank 54 temporarily reserves the ink in the liquid ejection head 1. The ink sub tank 54 is stored in the storage portion 53. The liquid ejection chip 3 is provided to a bottom portion of the storage portion 53, and details are described later. The liquid ejection chip 3 ejects the ink supplied from the ink sub tank 54 onto the ejection target medium P.

Note that, although illustration is omitted, a liquid connector insertion port is provided in a wall surface of the storage portion 53. A liquid connector provided to a tip of the ink supply tube 59 in FIG. 1A is inserted into the liquid connector insertion port and connected liquid-tightly. With this configuration, an ink supply path from the ink tank 2 to the liquid ejection head 1 by way of the external pump 71 is formed. In the present embodiment, the four types of inks are used. Therefore, four groups each including the ink tank 2, the external pump 71, the ink supply tube 59, and the ink sub tank 54 are provided for the inks, respectively. Accordingly, four ink supply paths corresponding to the inks are formed independently. Thus, in the present embodiment, the liquid ejection apparatus 50 includes an ink supply system in which the ink is supplied from the ink tank 2 provided outside the liquid ejection head 1.

A first support member 4 and a second support member 7 are provided between the storage portion 53 and the liquid ejection chip 3. An electric wiring member 5 is provided below the liquid ejection chip 3. Specifically, an ink supply port and an ink collection port are provided in the first support member 4. An opening is provided in the second support member 7. The liquid ejection chip 3 is bonded and fixed to the first support member 4. The first support member 4 is bonded and fixed to the second support member 7. The second support member 7 holds the electric wiring member 5 to be electrically connected with the liquid ejection chip 3. The electric wiring member 5 applies an electric signal to eject the ink and an electric signal to circulate the ink to the liquid ejection chip 3.

Note that, in the present embodiment, the liquid ejection apparatus 50 does not include an ink collection system to collect the ink in the liquid ejection head 1 into the ink tank 2. Therefore, the liquid ejection head 1 is provided with the liquid connector insertion port to connect the liquid connector of the ink supply tube 59 but is not provided with a connector insertion port to connect a tube collecting the ink into the ink tank 2.

FIG. 2B illustrates a case where the liquid ejection chip 3 is formed of one chip corresponding to four colors. That is, FIG. 2B illustrates a case where the number of colors that can be ejected by one liquid ejection chip 3 is four colors. The liquid ejection chip 3 includes multiple ejection orifices and a pad used for electric implementation. The four colors are, for example, black, cyan, magenta, and yellow, and rows are formed for each color. The rows are formed along the conveyance direction Y and arranged at intervals along the direction X. Each row includes the multiple ejection orifices. The multiple ejection orifices are arranged at equal intervals along the Y direction. The ejection orifices in each row may not be arranged at intervals in the X direction and may be arranged in one row along the Y direction. Alternatively, only black may be arranged in two rows while the other three colors may be arranged in three rows, and the four colors may be arranged in five rows in total. Note that, the liquid ejection chip 3 in FIG. 2A illustrates a configuration example of four colors per chip. That is, the liquid ejection chip 3 in FIG. 2A illustrates an example of the case in FIG. 2B.

FIG. 2C illustrates a case where the liquid ejection chip 3 is formed of one chip corresponding to two colors. In this case, two chips are used. That is, FIG. 2C illustrates a case where the number of colors that can be ejected by one liquid ejection chip 3 is two colors. In a case where the liquid ejection chip 3 is implemented on the liquid ejection head 1, two liquid ejection chips 3 may be implemented on one liquid ejection head 1, or two liquid ejection heads 1, each of which includes one liquid ejection chip 3 implemented thereon, may be prepared.

FIG. 2D illustrates a case where the liquid ejection chip 3 is formed of one chip corresponding to one color. In this case, four chips are used. That is, FIG. 2D illustrates a case where the number of colors that can be ejected by one liquid ejection chip 3 is one color. In a case where the liquid ejection chip 3 is implemented on the liquid ejection head 1, four liquid ejection chips 3 may be implemented on one liquid ejection head 1, or four liquid ejection heads 1, each of which includes one liquid ejection chip 3 implemented thereon, may be prepared.

Note that, in a case where a case of implementing multiple liquid ejection chips 3 on one liquid ejection head 1 is assumed as FIGS. 2C and 2D, a chip length of each liquid ejection chip 3 may be different. Additionally, the number of colors for the liquid ejection chip 3 is not particularly limited, and a variety of combinations of the number of colors may be applied. For example, although an example in which the number of colors for the liquid ejection chip 3 in FIG. 2A is four colors is illustrated, the number of colors for the liquid ejection chip 3 may be more than four colors.

### Individual Flow Path; Straight Shape

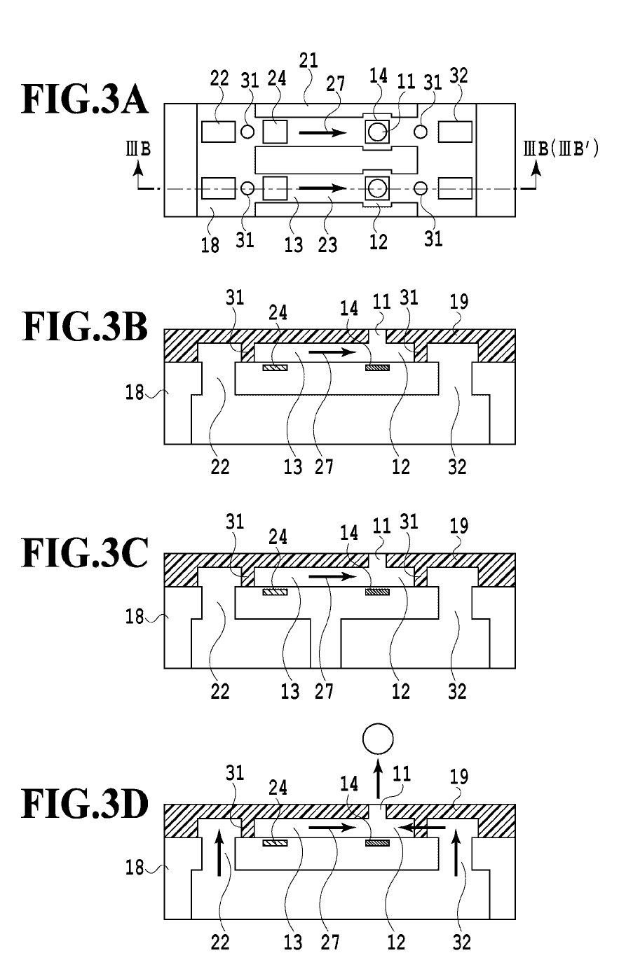

The liquid ejection head 1 includes multiple individual ejection units each including an individual flow path. The liquid ejection head 1 also includes a supply flow path to supply the liquid to the individual flow path of each individual ejection unit. FIG. 3 is a diagram describing the vicinity of an ejection orifice 11 of the individual ejection unit including an individual flow path 23 having a straight shape. FIG. 3A is a plan view that is viewed from a direction in which a liquid droplet is ejected from the ejection orifice 11 of the individual ejection unit. FIG. 3B is a IIIB-IIIB cross-sectional view of FIG. 3A. FIG. 3C is a IIIB-IIIB' cross-sectional view of FIG. 3A, and FIG. 3B is a cross-sectional view in which a configuration of the inside of a substrate 18 is different.

The individual ejection unit includes the ejection orifice 11, a pressure chamber 12, a first energy generation element 14 (also referred to as an ejection energy generation element 14), and a second energy generation element 24 (also referred to as a circulation energy generation element 24).

The pressure chamber 12 is formed for each ejection orifice 11 by partitioning a space between the substrate 18 and an orifice plate 19 by a partition 21. The ejection orifice 11 is an opening portion formed in a part of the orifice plate 19. A meniscus of the ink that flows through the pressure chamber 12 is formed in the ejection orifice 11, and an ejection orifice interface as an interface between the ink and the atmosphere is formed. The ejection orifice 11 ejects the liquid.

The individual flow path 23 extends in a second direction crossing (in the present embodiment, orthogonal to) a direction in which the ejection orifices 11 are arrayed to form a row (first direction). The individual flow path 23 includes the pressure chamber 12, an inlet port (upstream) side connection flow path 13, and an outlet port (downstream) side connection flow path. The inlet port side connection flow path 13 communicates with one end portion of the pressure chamber 12. The outlet port side connection flow path communicates with the other end portion of the pressure chamber 12.

A first supply opening 22 is provided on one end side of the individual flow path 23. The first supply opening 22 is an opening portion passing through the inside of the substrate 18 from a not-illustrated common flow path to an upstream side of the individual flow path 23. A second supply opening 32 is provided on the other end side of the individual flow path 23. The second supply opening 32 is an opening portion passing through the inside of the substrate 18 from the not-illustrated common flow path to a downstream side of the individual flow path 23. The individual flow path 23 is supplied with the liquid via the first supply opening 22 and the second supply opening 32.

In the substrate 18, the first energy generation element 14 is formed closer to the second supply opening 32 than the first supply opening 22. The first energy generation element 14 is an element that generates energy to eject the liquid in the pressure chamber 12 from the ejection orifice 11. Specifically, the first energy generation element 14 can eject the ink from the ejection orifice 11 by utilizing bubbling energy generated by bubbling the liquid (also referred to as the ink) in the pressure chamber 12 by heating and driving. In the present embodiment, an electrothermal conversion element is used as the first energy generation element 14; however, it is not particularly limited thereto. For example, a piezoelectric element may be used as the first energy generation element 14.

In the substrate 18, the second energy generation element 24 is formed closer to the first supply opening 22 than the second supply opening 32. The second energy generation element 24 is an element that generates energy to generate a circulatory flow of the ink in the individual flow path 23 in a direction indicated by an arrow 27. In the present embodiment, an electrothermal conversion element is used as the second energy generation element 24; however, it is not particularly limited thereto. For example, a piezoelectric element may be used as the second energy generation element 24.

Here, the straight shape is described. The straight shape means that the shape of the individual flow path 23 is formed such that two end portions of the individual flow path 23 are at positions sandwiching the ejection orifice 11, and a direction passing through the two end portions of the individual flow path 23 extends in a direction crossing (in the example in FIG. 3, a direction orthogonal to) the direction along the row of the ejection orifices 11. In other words, in the individual flow path 23, the first energy generation element 14 and the second energy generation element 24 are arranged in a direction crossing the direction along the row of the ejection orifices 11.

Additionally, the inlet port side connection flow path 13 is formed on a second energy generation element 24 side. The inlet port side connection flow path 13 is formed of a part of the individual flow path 23 on the second energy generation element 24 side and the first supply opening 22. On the other hand, a flow-out flow path is formed on a first energy generation element 14 side. The flow-out flow path is formed of another part of the individual flow path 23 on the first energy generation element 14 side and the second supply opening 32.

Next, a flow of the ink that flows through the individual flow path 23 is described. The flow of the ink that flows through the individual flow path 23 is categorized into two flows. A first flow of the ink is a flow for refilling after the ink is ejected from the ejection orifice 11 with the liquid ejection apparatus 50 driving the first energy generation element 14. A second flow of the ink is a flow to generate the circulatory flow in the direction of the arrow 27 with the liquid ejection apparatus 50 driving the second energy generation element 24.

### First Flow of Ink

A state in which the liquid ejection apparatus 50 drives the first energy generation element 14 to eject the ink from the ejection orifice 11 is illustrated in FIG. 3D. FIG. 3D is a diagram describing the flow-in of the ink in a case where the first energy generation element 14 is driven. In the example in FIG. 3D, the ink is supplied from each of the first supply opening 22 and the second supply opening 32 along with the ejection of the ink from the ejection orifice 11. Therefore, the ink flows into the pressure chamber 12 from both the first supply opening 22 and second supply opening 32.

### Second Flow of Ink

On the other hand, in a case where the second energy generation element 24 is driven to generate the circulatory flow, the ink flows into the individual flow path 23 via the first supply opening 22, and the ink flows out from the individual flow path 23 via the second supply opening 32. In the present embodiment, with the liquid ejection apparatus 50 returning the ink that flows out from the second supply opening 32 to the first supply opening 22 to circulate the ink, the liquid ejection apparatus 50 generates the circulatory flow of the ink in the direction indicated by the arrow 27 in the individual flow path 23. In FIG. 3C, an example in which the first supply opening 22 and the second supply opening 32 are commonalized in the liquid ejection chip 3 is illustrated. FIG. 3D is an example in which each of the first supply opening 22 and the second supply opening 32 is provided as an individual flow path, and each individual flow path is commonalized outside the liquid ejection head 1.

The circulatory flow of the ink is further described. The ink includes a volatile component such as moisture and a solid content. In a case of using the liquid ejection head 1, the ejection of the ink from the ejection orifice 11 may be unstable because of the evaporation of the volatile component in the ink from the ejection orifice 11, the condensation of the solid content in the ink in the vicinity of the ejection orifice 11 along with the evaporation of the volatile component in the ink, and the like. Therefore, various ideas have been considered to prevent the unstable ejection of the ink from the ejection orifice 11.

For example, a not-illustrated cap member may be provided at a position deviated in the X direction from the conveyance path of the ejection target medium P. The shape of the cap member is formed in a shape that can cover an ejection orifice surface in which the ejection orifice 11 of the liquid ejection head 1 is provided. In a case where the liquid ejection head 1 performs no printing operation on the ejection target medium P, the cap member can prevent drying of the ejection orifice 11 and can protect the ejection orifice 11 by covering the ejection orifice surface in which the ejection orifice 11 of the liquid ejection head 1 is provided.

In addition, a not-illustrated ink suction mechanism may be provided. In a case where the cap member and the ink suction mechanism are provided, the cap member is used in cooperation with an ink suction operation from the ejection orifice 11. The ink suction operation refreshes the ink in the vicinity of the ejection orifice 11; for this reason, it is possible to maintain the quality of the image quality of the obtained image.

Additionally, in a case where the liquid ejection head 1 performs no printing operation on the ejection target medium P, it is possible to discard the condensed ink by performing an ejection operation called preliminary ejection (also referred to as spitting). Moreover, it has also been known that, in a case where the liquid ejection head 1 performs the printing operation on the ejection target medium P, an ejection operation called preliminary ejection (also referred to as paper surface preliminary ejection or in-page preliminary ejection) is performed. The paper surface preliminary ejection or the in-page preliminary ejection is an ejection operation to eject an unnoticeable amount of the ink to an unnoticeable position so as not to affect the image quality on the ejection target medium P. The ejection operations contribute greatly to improving the image quality of the image; however, a part of the ink is discarded to refresh the ejection orifice 11. Therefore, preferably, there is a demand to reduce the amount of waste ink as much as possible.

To this end, it is possible to generate the circulatory flow of the ink by providing the second energy generation element 24 that heats the ink in the individual flow path 23 in the substrate 18. With the circulatory flow of the ink, it is possible to suppress the drying of the ejection orifice 11 and the condensation of the ink in the vicinity of the ejection orifice 11 while suppressing the amount of waste ink. From another angle, it is possible to reduce the number of times of the preliminary ejection of the ink and the suction of the ink as much as possible. Additionally, with the number of times of the preliminary ejection of the ink being reduced as much as possible, it is possible to conduct the improvement of the throughput of the overall liquid ejection apparatus 50 and the improvement of yield. Note that, with the second energy generation element 24 being provided to at least a part of the individual flow path 23 out of the multiple individual flow paths 23 included in the liquid ejection head 1, it is possible to achieve the above-described effect.

Moreover, the liquid ejection head 1 in FIG. 1A may have a configuration in which the second energy generation element 24 is provided to all the portions corresponding to the four types of inks or may have a configuration in which the second energy generation element 24 is included in only a portion corresponding to one type of ink. That is, the liquid ejection head 1 may have a configuration in which only at least one type of ink out of multiple types of inks is circulated.

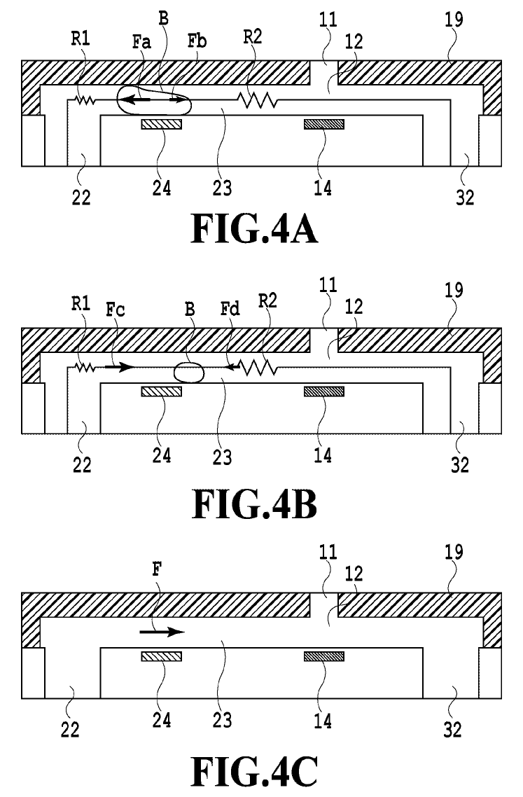

Note that, in the circulation flow path of the ink, a filter 31 as illustrated in FIG. 3A may be provided to remove a foreign matter included in the ink. The filter 31 is a protrusion that is formed by making a part of the orifice plate 19 protrude toward the substrate 18. In the examples in FIGS. 3A-3D, the filter 31 is provided at a position on one end side of the individual flow path 23 and a position on the other end side. In the circulation flow path of the ink, the one end side of the individual flow path 23 corresponds to a flow-in side of the ink, and the other end side of the individual flow path 23 corresponds to a flow-out side of the ink. The filter 31 may be provided at a position between the first energy generation element 14 and the second energy generation element 24 in the individual flow path 23. In a case where the filter 31 is provided at the position between the first energy generation element 14 and the second energy generation element 24 in the individual flow path 23, the filter 31 may not be provided at the position on the one end side of the individual flow path 23 and the position on the other end side. Next, the principle of generation of the circulatory flow of the ink is described with reference to FIG. 4.

### Principle of Generation of Circulatory Flow of Ink

FIG. 4 is a diagram describing the principle of generation of the circulatory flow of the ink. In FIG. 4, illustration of the filter 31 is omitted to simplify the description. FIG. 4A is a IIIB-IIIB cross-sectional view of the individual ejection unit of FIG. 3A and is a cross-sectional view describing a generation and growing process of an air bubble B generated by heating the ink with the second energy generation element 24 and causing film boiling of the ink. FIG. 4B is a IIIB-IIIB' cross-sectional view of the individual ejection unit of FIG. 3A and is a cross-sectional view describing a contraction process of the air bubble B generated by heating the ink with the second energy generation element 24 and causing film boiling of the ink. FIG. 4C is a IIIB-IIIB' cross-sectional view of the individual ejection unit of FIG. 3A and is a cross-sectional view describing a process after bubble disappearance of the air bubble B generated by heating the ink with the second energy generation element 24 and causing film boiling of the ink. Next, the generation and growing process, the contraction process, and the process after bubble disappearance of the air bubble B are described.

### Generation and Growing Process of Air Bubble B

As illustrated in FIG. 4A, the second energy generation element 24 is arranged at a position closer to the first supply opening 22 out of the first supply opening 22 and the second supply opening 32. Therefore, with the circulatory flow of the ink being generated, a flow resistance R1 that is generated in a flow path between the second energy generation element 24 and the first supply opening 22 is smaller than a flow resistance R2 that is generated in a flow path between the second energy generation element 24 and the second supply opening 32. Accordingly, as illustrated in FIG. 4A, due to the difference between the flow resistance R1 and the flow resistance R2, the air bubble B generated by film boiling of the ink grows so as to be lean to a side of the flow path of the relatively small flow resistance R1. Therefore, a flow vector Fa of the ink flowing toward the flow path on the side where the flow resistance R1 is generated is greater than a flow vector Fb of the ink flowing toward the flow path on the side where the flow resistance R2 is generated. Note that, a circuit including the flow resistances R1 and R2 is an equivalent circuit in which the flow resistance generated by the circulatory flow of the ink in the flow path including the individual flow path 23 is expressed by comparing to an electric resistance as an example.

### Contraction Process of Air Bubble B

In the contraction process of the air bubble B, the ink flows in so as to fill the inner volume generated by the contraction of the air bubble B. In this process, as illustrated in FIG. 4B, a flow vector Fc of the ink flowing from the first supply opening 22 on the flow resistance R1 side is greater than a flow vector Fd of the ink flowing from the second supply opening 32 on the flow resistance R2 side. Additionally, a bubble disappearance position of the air bubble B is deviated to the flow path close to the second supply opening 32 from the position above the second energy generation element 24.

### Process After Bubble Disappearance of Air Bubble B

As described with reference to FIG. 4B, there is a relationship of Fc > Fd. Therefore, a flow vector F of the circulatory flow of the ink that flows from the first supply opening 22 to the second supply opening 32 is generated. The magnitude of the flow vector F is affected by a ratio between the flow resistances R1 and R2 and the size of the air bubble B. For example, a case of using the second energy generation element 24 is assumed. In this case, it is preferable for the arrangement position of the second energy generation element 24 to be closer to one of the two end portions of the individual flow path 23 than the arrangement position of the first energy generation element 14. Specifically, it is preferable to set a flow resistance ratio R1/R2 within a range from 0.05 to 0.40. With the flow resistance ratio R1/R2 being set within the range from 0.05 to 0.40, it is possible to set the flow vector F of the circulatory flow of the ink to the local maximum value. With the flow vector Fa of the ink being increased, and the flow vector Fc of the ink being increased, the flow vector F of the circulatory flow of the ink is increased, and the circulatory flow of the ink is increased. Therefore, it is preferable to reduce the flow resistance R1. Additionally, it is preferable to reduce the flow vector Fb of the ink as much as possible and to reduce the flow vector Fd of the ink. Therefore, it is preferable to increase the flow resistance R2. According to the above, it is preferable to reduce the flow resistance R1 and to increase the flow resistance R2. That is, it is preferable to reduce the flow resistance ratio R1/R2. Moreover, a great size of the air bubble B, that is, a great volume of the air bubble B means an increase of an excluded volume of fluid in the individual flow path 23, and therefore the circulatory flow is increased. An element that contributes to the increase of the circulatory flow includes the following, for example. The element that contributes to the increase of the circulatory flow includes an increase in the size of the second energy generation element 24. Additionally, the element that contributes to the increase of the circulatory flow includes an increase in a width and a height of the flow path on a first supply opening 22 side and a relative reduction in the flow path resistance R1. Moreover, the element that contributes to the increase of the circulatory flow includes a reduction in the viscosity of the ink. Furthermore, the element that contributes to the increase of the circulatory flow includes an increase in the temperature of the liquid ejection head 1. Additionally, the element that contributes to the increase of the circulatory flow includes changing a driving pulse to a double pulse. The changing of the driving pulse to the double pulse means the following. First, the ink around the flow path above the second energy generation element 24 is heated by applying a short pulse, which does not cause the generation of the air bubble in the flow path above the second energy generation element 24, to the second energy generation element 24. Subsequently, a greater air bubble grows with application of a main pulse, which generates the air bubble to circulate the ink, to the second energy generation element 24. Specifically, with the first pulse, an ink temperature around the heater in a range as wide as possible is raised to a temperature before reaching a boiling point, and with the second pulse, the ink in a wide range is vaporized immediately. Thus, the air bubble is increased. That is, the air bubble volume is increased by inputting the pulse twice.

Additionally, a part of the ink that flows by the circulatory flow of the ink enters the inside of the ejection orifice 11. Thus, the condensed ink in the ejection orifice 11 is transferred to the flow path on a second supply opening 32 side while a fresh ink flows into the ejection orifice 11 from the flow path on the first supply opening 22 side through the individual flow path 23. Thus, stagnation of the condensed ink in the ejection orifice 11 is prevented. Therefore, it is possible to maintain an initial ink ejection state while suppressing an effect of the condensed ink.

The circulatory flow of the ink is a transitional flow along with the growing process and the contraction process in a case where the air bubble B is generated. Therefore, after the bubble disappearance of the air bubble B, an inertial circulatory flow of the ink is attenuated over time and stops after a certain period of time. Accordingly, in order to generate the circulatory flow stationarily for a certain period of time, it is preferable to drive the second energy generation element 24 repeatedly. Note that, as long as the condensed ink stagnating in the ejection orifice 11 can be discharged, a driving cycle of the second energy generation element 24 is not particularly limited. It should be noted that the circulatory flow of the ink is the transitional flow along with the growing process and the contraction process in a case where the air bubble B is generated. Therefore, in a case where the driving is performed at a high driving frequency such as 100 kHz taking into consideration a cycle of 10 μs that is time between the generation and the bubble disappearance of the air bubble B, a phenomenon that inhibits the promotion of the circulatory flow of the ink may occur. Accordingly, for example, it is preferable to drive the second energy generation element 24 in a driving cycle at about 100 Hz to several tens of kHz.

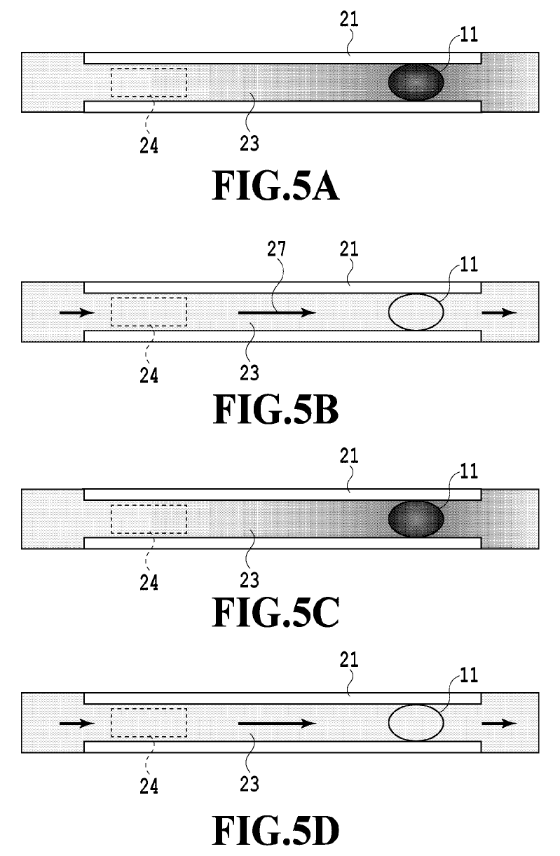

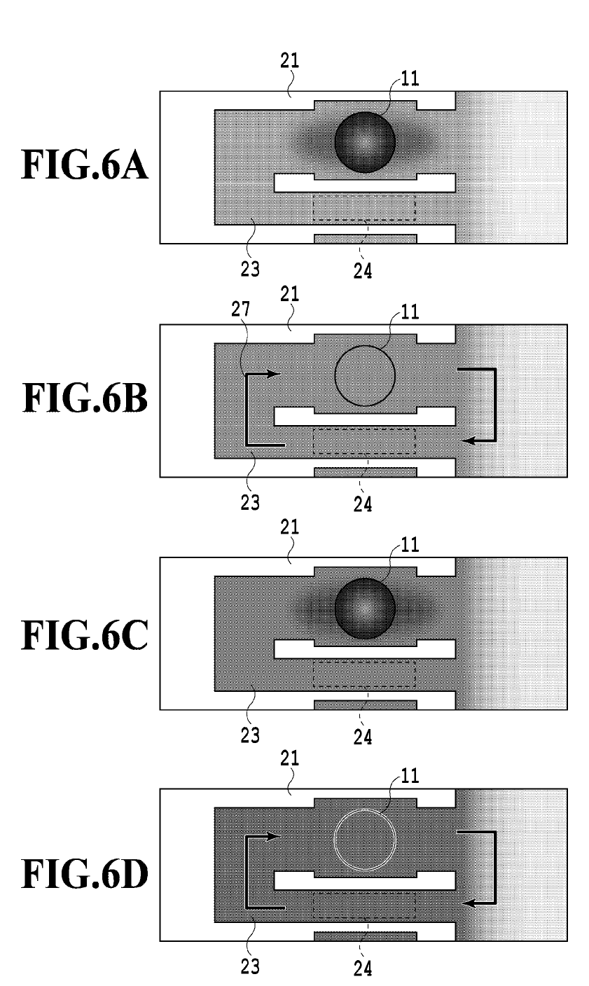

Specifically, since the circulatory flow of the ink is maintained as the driving frequency of the second energy generation element 24 is high, an effect of discharging the condensed ink resulting from the circulatory flow of the ink is improved. However, the higher the driving frequency of the second energy generation element 24, the greater the rise of the ink temperature by heating of the second energy generation element 24 resulting from driving of the second energy generation element 24 is assumed. Therefore, it is preferable to properly control the number of times of driving of the second energy generation element 24. Next, resolution of the condensation of the ink along with the circulatory flow of the ink is described with reference to FIGS. 5 and 6.

### Resolution of Condensation of Ink; Straight Shape

FIG. 5 is a diagram describing a state of resolution of a concentration along with the circulatory flow of the ink in the individual flow path 23 having the straight shape. FIG. 5A is a diagram illustrating a state in which the circulatory flow of the ink is temporarily halted. FIG. 5B is a diagram illustrating a state immediately after the circulatory flow of the ink is generated by driving the second energy generation element 24 after the state in FIG. 5A. FIG. 5C is a diagram illustrating a state in which the circulatory flow of the ink is temporarily halted after the state in FIG. 5B. FIG. 5D is a diagram illustrating a state immediately after the circulatory flow of the ink is generated by driving the second energy generation element 24 after the state in FIG. 5C. As illustrated in FIGS. 5A-5D, the individual flow path 23 having the straight shape has a configuration in which an inlet port and an outlet port of the circulatory flow of the ink are separated. Note that, hatching with dots is applied to the ink in the individual flow path 23, and hatching with dots at a high concentration is applied to a portion with the condensed ink to express the degree of the ink condensation.

As illustrated in FIG. 5A, in a state in which the circulatory flow of the ink is temporarily halted, the volatile component of the ink is evaporated from the ejection orifice 11. Therefore, the condensation of the ink progresses in the vicinity of the ejection orifice 11. Thereafter, with the second energy generation element 24 being driven, the circulatory flow of the ink is restarted. As a result, as illustrated in FIG. 5B, the ink condensation that has progressed in the vicinity of the ejection orifice 11 is resolved. Thereafter, once the circulatory flow of the ink is temporarily halted, as illustrated in FIG. 5C, as with FIG. 5A, the ink condensation progresses again in the vicinity of the ejection orifice 11. Thereafter, with the second energy generation element 24 being driven, the circulatory flow of the ink is restarted. As a result, as illustrated in FIG. 5D, as with FIG. 5B, the ink condensation that has progressed in the vicinity of the ejection orifice 11 is resolved. Therefore, the ink condensation in the entire individual flow path 23 is also resolved. As above, in the individual flow path 23 having the straight shape, the condensation state of the ink is reset every time the circulatory flow of the ink is temporarily halted and restarted repeatedly.

### Resolution of Concentration of Ink; U-Shape

FIG. 6 is a diagram describing a state of resolution of the concentration along with the circulatory flow of the ink in the individual flow path 23 having a U-shape. FIG. 6A is a diagram illustrating a state in which the circulatory flow of the ink is temporarily halted. FIG. 6B is a diagram illustrating a state immediately after the circulatory flow of the ink is generated by driving the second energy generation element 24 after the state in FIG. 6A. FIG. 6C is a diagram illustrating a state in which the circulatory flow of the ink is temporarily halted after the state in FIG. 6B. FIG. 6D is a diagram illustrating a state immediately after the circulatory flow of the ink is generated by driving the second energy generation element 24 after the state in FIG. 6C. As illustrated in FIGS. 6A-6D, the individual flow path 23 having the U-shape has a configuration in which the inlet port and the outlet port of the circulatory flow of the ink are adjacent to each other. Note that, hatching with dots is applied to the ink in the individual flow path 23, and hatching with dots at a high concentration is applied to a portion with the condensed ink to express the degree of the ink condensation.

As illustrated in FIG. 6A, in a state in which the circulatory flow of the ink is temporarily halted, the volatile component of the ink is evaporated from the ejection orifice 11. Therefore, the condensation of the ink progresses in the vicinity of the ejection orifice 11. Thereafter, once the second energy generation element 24 is driven, the circulatory flow of the ink is restarted. As a result, the state illustrated in FIG. 6B is obtained. The inlet port of the individual flow path 23 in FIG. 6A is adjacent to the outlet port of the individual flow path 23 in FIG. 6A. Therefore, the ink condensed in the vicinity of the ejection orifice 11 is discharged from the outlet port of the individual flow path 23, but a part of the discharged ink flows into the inlet port of the individual flow path 23 again. Therefore, a phenomenon in which not the entire individual flow path 23 is replaced with the fresh ink but is replaced with the ink that is slightly condensed (hereinafter, the phenomenon is referred to as recirculation condensation) occurs. Thereafter, once the circulatory flow of the ink is temporarily halted, as illustrated in FIG. 6C, the condensation of the ink progresses again in the vicinity of the ejection orifice 11 from the state in FIG. 6B, as with FIG. 6A. Thereafter, once the second energy generation element 24 is driven, the circulatory flow of the ink is restarted. As a result, as illustrated in FIG. 6D, the entire individual flow path 23 is replaced with the ink that is condensed more than that in FIG. 6B due to an effect of the recirculation condensation. As above, in the individual flow path 23 having the U-shape, every time the temporal halt and the circulation operation of the circulatory flow of the ink are repeated, the condensation state of the ink is not reset, and the condensation of the ink gradually progresses in the entire individual flow path 23. Therefore, the condensation state of the ink is deteriorated. Note that, even in a case where the temporal halt and the restarting of the circulatory flow of the ink are not repeated, if the condensation of the ink in the vicinity of the ejection orifice 11 progresses because the of the circulatory flow of the ink is temporarily halted for a long period of time, it is difficult to obtain the improvement effect of the condensation state of the ink even though the circulatory flow of the ink is restarted for the first time. This is because the improvement effect of the condensation state of the ink by the recirculation condensation is small.

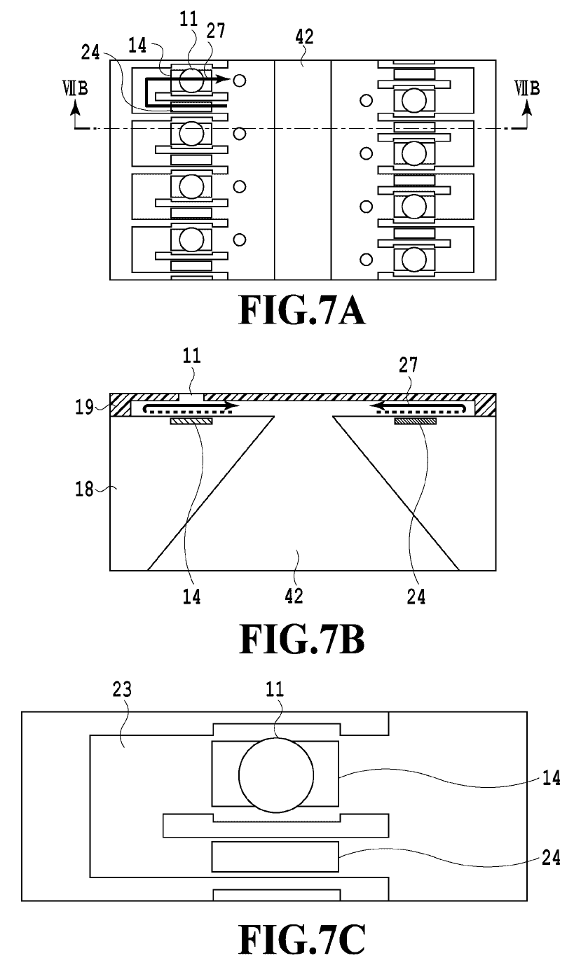

Accordingly, the individual flow path 23 having the straight shape and the individual flow path 23 having the U-shape have a different effect of the resolution of the concentration state of the ink by the temporal halt and the restarting of the circulatory flow of the ink due to a difference between the effects of the discharged condensed ink. Specifically, in a case of the individual flow path 23 having the straight shape, the condensation state of the ink also in the entire individual flow path 23 is likely to be resolved. On the other hand, in a case of the individual flow path 23 having the U-shape, the condensation state of the ink also in the entire individual flow path 23 is unlikely to be resolved due to the recirculation condensation. Therefore, in a case of the individual flow path 23 having the U-shape, there is a possibility of the unstable ejection of the ink according to the degree of the condensation in the entire individual flow path 23. Next, a configuration of the vicinity of the ejection orifice 11 in the individual flow path 23 having the U-shape is described with reference to FIG. 7.

### Configuration of Vicinity of Ejection orifice 11 in Individual Flow Path 23 Having U-Shape

FIG. 7 is a diagram describing the vicinity of the ejection orifice 11 in the individual flow path having the U-shape in detail. FIG. 7A is a plan view that is viewed from a direction in which the liquid droplet is ejected from the ejection orifice 11. FIG. 7B is a VIIB-VIIB cross-sectional view of FIG. 7A. FIG. 7C is an enlarged schematic view of the individual flow path 23 in FIG. 7A.

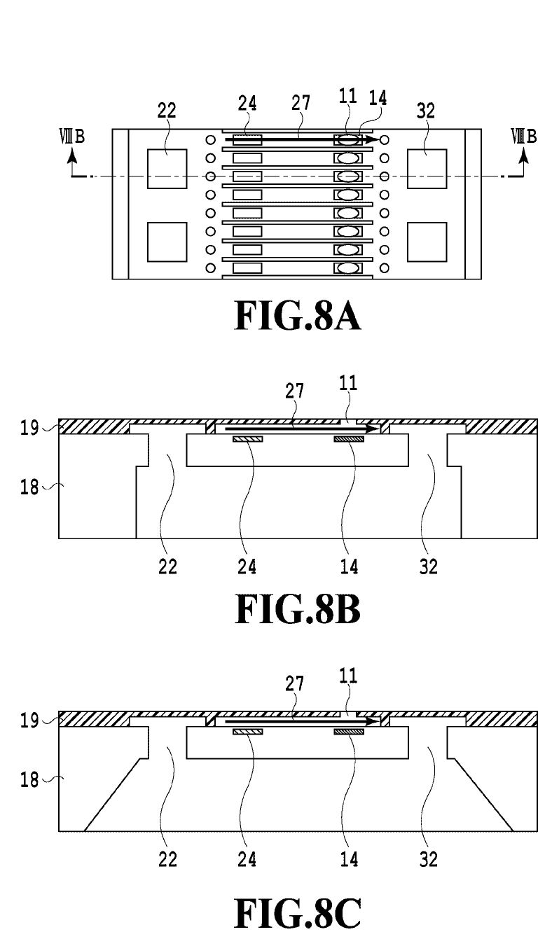

The ejection orifice 11 in FIGS. 7A and 7B is the opening portion formed in a part of the orifice plate 19. In the substrate 18, the first energy generation element 14 is formed at a position corresponding to a portion immediately below the ejection orifice 11. In the substrate 18, the second energy generation element 24 is also formed. The second energy generation element 24 generates the circulatory flow of the ink in the flow path including the individual flow path 23 in the direction indicated by the arrow 27. In the substrate 18, a supply groove 42 is formed to penetrate through the substrate 18 in a direction along the row of the ejection orifices 11 between a row of the first energy generation elements 14 and a row of the second energy generation elements 24. The supply groove 42 communicates with the individual flow path 23 and can supply the individual flow path 23 with the ink. Thus, not only a configuration in which multiple independent supply openings are provided as the first supply opening 22 and the second supply opening 32 in FIG. 3 but also a configuration in which the liquid is allowed to flow in and out by using a large opening as the common supply groove 42 in FIG. 7 may also be applied. Next, a configuration of the vicinity of the ejection orifice 11 in the individual flow path 23 having the straight shape is described with reference to FIG. 8.

### Configuration of Vicinity of Ejection orifice 11 in Individual Flow Path 23 Having Straight Shape

FIG. 8 is a diagram describing the vicinity of the ejection orifice 11 in the individual flow path 23 having the straight shape in detail. FIG. 8A is a plan view that is viewed from the direction in which the liquid droplet is ejected from the ejection orifice 11. FIG. 8B is a VIIB-VIIB cross-sectional view of FIG. 8A. FIG. 8C is a VIIB-VIIB cross-sectional view of FIG. 8A and is a cross-sectional view in which a configuration of the inside of the substrate 18 is different from that in FIG. 8B. FIGS. 8B and 8C illustrate two examples of different shapes of a back side of the substrate 18 depending on a type of etching method performed on the substrate 18; however, the shape of the back side of the substrate 18 may be either shape. That is, the configuration of the inside of the substrate 18 may be any configuration.

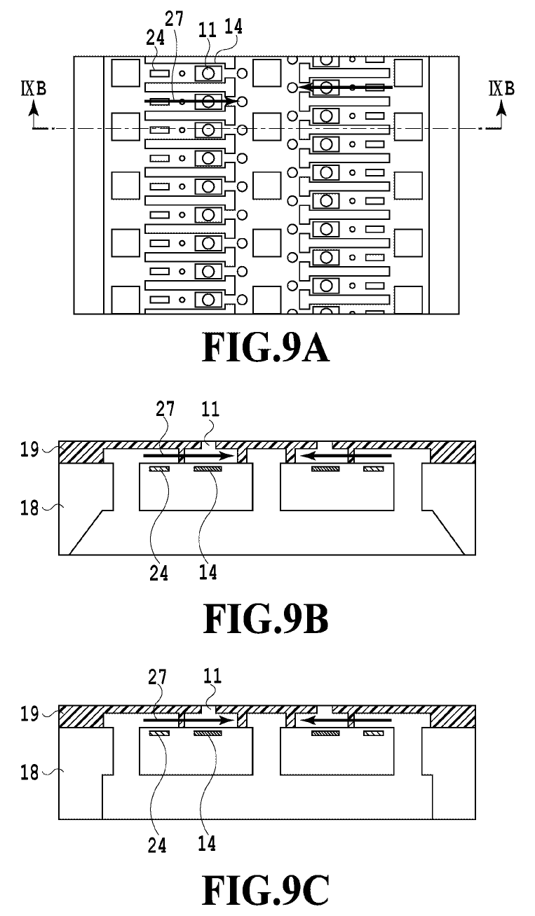

A different point from the configuration of the vicinity of the ejection orifice 11 in the individual flow path 23 having the U-shape is that, unlike the individual flow path 23 having the U-shape, it is a configuration of the straight shape in which the inlet port and the outlet port of the individual flow path 23 are not adjacent to each other, and the inlet port and the outlet port of the individual flow path 23 are separated from each other. Additionally, as illustrated in FIG. 8A, a direction connecting the two ends of the individual flow path 23 having the straight shape is orthogonal to the direction in which the ejection orifices 11 are arrayed to form a row. With the above-described arrangement configuration, the position at which the circulatory flow of the ink flows into the individual flow path 23 and the position at which the circulatory flow of the ink flows out are away from each other. Therefore, it is possible to suppress the flow of the ink condensed in the ejection orifice 11 again into the individual flow path 23. Accordingly, it is possible to suppress the effect of the condensation of the ink. Next, another configuration of the vicinity of the ejection orifice 11 in the individual flow path 23 having the straight shape is described with reference to FIG. 9.

### Another Configuration of Vicinity of Ejection orifice 11 in Individual Flow Path 23 Having Straight Shape

FIG. 9 is another schematic view describing the vicinity of the ejection orifice in the individual flow path 23 having the straight shape. FIG. 9A is a plan view that is viewed from the direction in which the liquid droplet is ejected from the ejection orifice 11. FIG. 9B is a IXB-IXB cross-sectional view of FIG. 9A. FIG. 9C is a IXB-IXB cross-sectional view of FIG. 9A and is a cross-sectional view in which the configuration of the inside of the substrate 18 is different from that in FIG. 9B. FIGS. 9B and 9C illustrate two examples of different shapes of the back side of the substrate 18 depending on the type of etching method performed on the substrate 18; however, the shape of the back side of the substrate 18 may be either shape. That is, the configuration of the inside of the substrate 18 may be any configuration. Additionally, a different point from FIG. 8 is that the number of rows of supply openings of the ink is increased by one from two rows to three rows. Thus, it is possible to double the number of rows of the ejection orifices 11 and to arrange the row of the ejection orifices 11 on a side close to the central supply opening of the ink. That is, the rows of the ejection orifices 11 are arranged on two sides along an array direction of the multiple supply openings of the ink on the central side. With the above-described arrangement, it is possible to increase the number of the supply openings of the ink by one from two rows to three rows and to double the number of the ejection orifices 11 from one row to two rows. Additionally, as illustrated in FIG. 9A, it is possible to arrange two rows of the ejection orifices 11 in a staggered pitch between the two rows of the ejection orifices 11. Additionally, no wiring region may be included between the supply openings in the central row of the supply openings of the ink. Therefore, the size and the resolution of the opening in the central row of the supply openings of the ink have a high degree of freedom. Thus, it is possible to increase the speed of refilling of the ejection orifice 11 and to achieve the high productivity. Note that, the position of the ejection orifice 11 and the position of the supply opening of the ink may be displaced depending on the routing of the wiring. Next, the ink according to the present embodiment is described.

### Ink

As described above, although the degree of the resolution of the condensation of the ink is different based on a difference between the flow path configurations including the individual flow path 23, it is possible to achieve the following effect by generating the circulatory flow of the ink in the individual flow path 23 by using the second energy generation element 24. That is, it is possible to suppress the effect of the condensed ink that is thickened by the evaporation of the volatile component of the ink in the ejection orifice 11. Therefore, since it is possible to maintain a good ejection state of the ink, it is possible to further reduce the effect of changing in an ejection speed of the ink. Accordingly, it is possible to conduct the stable ejection of the ink.

On the other hand, depending on the use application of the liquid ejection head 1 and the liquid ejection apparatus 50 on which the liquid ejection head 1 is mounted, it may be assumed that the inks of different types of color material, the inks of different content of the solid content, and the like are used. That is, as the performance of the liquid ejection head 1, it is preferable to maintain the stability of the ejection of the ink by using any type of ink.

For example, as a case that is caused by the water in the ink, there is a case in which a change such as curling (also referred to as warping) and cockling (also referred to as wavy wrinkles) may occur on plain paper. In this case, the use of the ink with a reduced amount of moisture may be considered. Additionally, the ink with a small amount of moisture has a high concentration of the solid content of the ink such as organic solvent other than water, pigment, and resin. Therefore, the viscosity of the ink is likely to rise rapidly along with the moisture evaporation of the ink. Accordingly, the ink with a small amount of moisture is likely to cause a reduction in the stability of the ejection of the ink. Therefore, in a case of using the ink with a small amount of moisture, it is possible to suppress the rising of the viscosity of the ink by generating the circulatory flow of the ink in the flow path configuration including the individual flow path 23 according to the present embodiment. In general, the ink with a great amount of solid content has a solid content of 10 wt%. That is, it is preferable to apply the present embodiment to the ink with a content of the solid content of 10 wt% (also referred to as % by mass) or more.

A relationship between an operation temperature of the liquid ejection head 1 and the viscosity of the ink is described. There is a case where the second energy generation elements 24 arranged in the entire liquid ejection chip 3 are driven and controlled, and the temperature of the liquid ejection head is heated until the temperature of the liquid ejection head 1 reaches a certain temperature to use the liquid ejection head 1. The viscosity of the ink is changed according to the temperature of the ink. Therefore, the viscosity of the ink at the operation temperature of the liquid ejection head 1 affects the stability of the ejection of the ink.

A relationship between a circulatory flow velocity of the ink and the driving frequency of each of the first energy generation element 14 and the second energy generation element 24 is described. In a case where the circulatory flow of the ink is generated by the second energy generation element 24, it is possible to achieve the circulatory flow velocity in which an instantaneous flow velocity of the ink in the range of several tens of mm/s to 1000 mm/s. The average flow velocity over a time window on the order of several hundred μs depends on the driving frequency of the second energy generation element 24. This is because, in a case where the circulatory flow of the ink is generated by the second energy generation element 24, the circulatory flow of the ink is the transitional circulatory flow that is attenuated over time and stops after a certain period of time. On the other hand, in a case where the circulatory flow of the ink is generated by the first energy generation element 14, it is possible to drive at a frequency of about 10 kHz to 20 kHz that is comparable to the driving frequency of the first energy generation element 14 (also referred to as ejection frequency). In this case, the average flow velocity of the circulatory flow of the ink may be several mm/s to 100 mm/s. Next, a relationship between a pigment concentration and the resolution of the condensation of the ink is described.

### Ink With High Concentration of Pigment Concentration

A case of the ink with a high concentration of the pigment concentration is described. For example, in a case of using the ink with a concentration in which the viscosity of the ink is 3 cP or greater and 6 cP or smaller at the operation temperature of the liquid ejection head 1, the thickening of the ink in the vicinity of the ejection orifice 11 is likely to progress according to non-ejection time of the ink (also referred to as halt time of the circulatory flow of the ink). Therefore, the ejection speed of the ink is likely to be changed. Therefore, the stability of the ejection of the ink is likely to be reduced. In order to suppress the reduction in the stability of the ejection of the ink, it is preferable to circulate the ink by generating the circulatory flow of the ink while the halt time of the circulatory flow of the ink is still short. Therefore, it is preferable to conduct the resolution of the condensation of the ink by the stationary circulation of the ink or the transitional circulation of the ink with a high frequency. To this end, it is possible to perform the transitional circulation of the ink by driving the second energy generation element 24. Therefore, it is possible to contribute to the resolution of the condensation of the ink in the vicinity of the ejection orifice 11 by driving the second energy generation element 24 and restarting the circulatory flow of the ink with a high frequency from a halt state of the circulatory flow of the ink.

### Ink With Low Concentration of Pigment Concentration

A case of the ink with a low concentration of the pigment concentration is described. For example, in a case of using the ink with a concentration in which the viscosity of the ink is 1 cP or greater and 2 cP or smaller at the operation temperature of the liquid ejection head 1, there is a possibility that the thickening of the ink in the vicinity of the ejection orifice 11 progresses according to the non-ejection time of the ink (also referred to as the halt time of the circulatory flow of the ink). Therefore, although there is a possibility that the ejection speed of the ink is changed, the change in the ejection speed of the ink is relatively smaller than that of the ink with the high concentration. On the other hand, in a case where the halt time of the circulatory flow of the ink is long, for example, there is a possibility that the thickening of the ink in the vicinity of the ejection orifice 11 progresses according to non-printing driving time (also referred to as stop time). Therefore, in a case of resuming the operation after stopping without printing for a certain time, it is preferable to execute recovery processing associated with the waste ink including a suction operation of the ink, a wiping operation, and preliminary ejection that is a combination of the above. To this end, with the second energy generation element 24 being driven, restarting of the circulatory flow of the ink functions as the recovery operation, and it is possible to contribute to the resolution of the condensation of the ink in the vicinity of the ejection orifice 11 without generating the waste ink. Additionally, depending on the stop time, it is also possible to prevent the generation of the waste ink by the recovery processing that is merely the restarting of the circulatory flow of the ink by driving the second energy generation element 24. Alternatively, it is also possible to perform the recovery processing that reduces the waste ink as much as possible by combining the recovery by restarting the circulatory flow of the ink and the suction operation to remove the air bubble B in the liquid ejection head 1 that is different from the resolution of the condensation of the ink.

### More Preferable Configuration for Resolution of Condensation of Ink

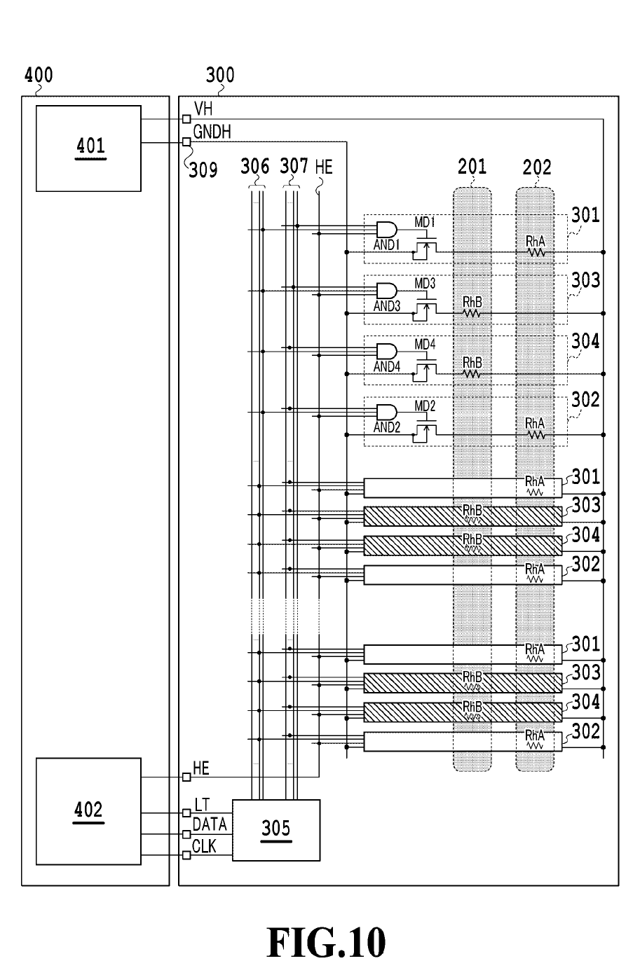

As described above, in either case, whether the ink with the high concentration or the ink with the low concentration, it is preferable to restore the ink to the initial fresh ink as much as possible to suppress the effect of the condensed ink. Therefore, in a case of driving the second energy generation element 24, the less the effect of the recirculation condensation, the higher the circulation effect can be achieved. That is, it is possible to achieve the higher circulation effect with the configuration of the individual flow path 23 having the straight shape than the U-shape. Next, an electric circuit configuration to drive and control the first energy generation element 14 and the second energy generation element 24 according to the present embodiment is described with reference to FIGS. 10-20.

### Heater Selection Circuit

FIG. 10 is a diagram illustrating a circuit configuration example of a printing element substrate 300 according to the present embodiment. The printing element substrate 300 is supplied with various signals from a main substrate 400. The main substrate 400 includes a power source circuit 401 and a controller 402. The power source circuit 401 applies a power source voltage to the printing element substrate 300 via a power source line VH. The power source circuit 401 and the printing element substrate 300 are connected to each other via a ground line GNDH. The ground line GNDH is included in a ground wiring layer. The ground wiring layer sets a reference potential of the printing element substrate 300. Therefore, the ground line GNDH functions as the reference potential of the printing element substrate 300. The controller 402 is mainly formed of a ROM, a RAM, and a CPU and supplies various electric signals to the printing element substrate 300. The controller 402 is connected with the printing element substrate 300 via an enable signal line HE, a latch signal line LT, a data signal line DATA, and a clock signal line CLK. The controller 402 supplies an enable signal via the enable signal line HE. The enable signal is a signal to control the time, in which an element as a control target is turned on and a current flows, by a pulse width. The enable signal is a signal for the adjustment to generate more desirable heat energy taking into consideration the manufacturing irregularities of a heater resistance value in the printing element substrate 300, the manufacturing irregularities of the power source circuit 401, and a voltage drop of a power source wiring in a case of driving multiple heaters simultaneously. In the present embodiment, an example in which the enable signal line HE is shared between ejection and circulation to reduce the number of signal terminals is described; however, it is also possible to set different pulse widths for ejection and circulation by providing the enable signal line HE individually for ejection and circulation. Note that, it is preferable to apply the following configuration in a case where the enable signal line HE is shared between ejection and circulation as the present embodiment. That is, it is preferable to adjust the pulse width of the enable signal under the assumption that an ejection heater RhA and a circulation heater RhB are formed in the same process of the semiconductor manufacturing process and have the same manufacturing irregularities (a resistance value deviation amount from an ideal value). The controller 402 supplies a latch signal to the printing element substrate 300 via the latch signal line LT. The controller 402 supplies a data signal to the printing element substrate 300 via the data signal line DATA. The controller 402 supplies a clock signal to the printing element substrate 300 via the clock signal line CLK.

The printing element substrate 300 includes ejection modules 301 and 302 and circulation modules 303 and 304. The ejection modules 301 and 302 includes the ejection heaters RhA, ejection driving elements MD1 and MD2, and ejection logic circuits AND1 and AND2, respectively. The ejection heater RhA is an ejection energy generation element. The first energy generation element 14 is also the ejection energy generation element. That is, although the ejection heater RhA and the first energy generation element 14 indicate the same, the terms are used differently depending on whether it is a circuit element or an element arranged in a structure of the individual flow path 23. The ejection driving elements MD1 and MD2 are elements that allow the current to flow to the ejection heaters RhA, respectively. The ejection logic circuits AND1 and AND2 are elements that selectively drive the ejection driving elements MD1 and MD2, respectively. The printing element substrate 300 generates heat by allowing the current to flow to the ejection heater RhA. Thus, with the ink bubbling and being ejected, it is possible to perform printing on the ejection target medium P.

The circulation modules 303 and 304 include the circulation heaters RhB, circulation driving elements MD3 and MD4, and circulation logic circuits AND3 and AND4, respectively. The circulation heater RhB is a circulation energy generation element. The second energy generation element 24 is also the circulation energy generation element. That is, although the circulation heater RhB and the second energy generation element 24 indicate the same, the terms are used differently depending on whether it is a circuit element or an element arranged in the structure of the individual flow path 23. The circulation driving elements MD3 and MD4 are elements that allow the current to flow to the circulation heaters RhB, respectively. The circulation logic circuits AND3 and AND4 are elements that selectively drive the circulation driving elements MD3 and MD4, respectively. The printing element substrate 300 generates heat by allowing the current to flow to the circulation heater RhB. Thus, the air bubble B of the ink grows, and it is possible to generate the circulatory flow in the flow path of the ink including the individual flow path 23.

Note that, in the ejection heater RhA, a piezoelectric element may be used as the element to eject the ink. In the circulation heater RhB, a piezoelectric element may be used as the element to circulate the ink. Each of the ejection driving elements MD1 and MD2 and the circulation driving elements MD3 and MD4 is an N-type high-voltage-proof transistor, which is therefore a transistor having higher voltage tolerance than a transistor used for the logic circuit. It is preferable for the high-voltage-proof transistor to be formed so as not to be broken by being applied with a great voltage (for example, 32 V) that a general logic circuit transistor forming a control unit cannot tolerate.

The printing element substrate 300 includes a control data supply circuit 305. The printing element substrate 300 is provided with a group selection signal line 306, a time-division selection signal line 307, and the enable signal line HE. The control data supply circuit 305 is electrically connected with each of the group selection signal line 306, the time-division selection signal line 307, and the enable signal line HE. Each of the group selection signal line 306, the time-division selection signal line 307, and the enable signal line HE is electrically connected with the ejection modules 301 and 302 and the circulation modules 303 and 304. Therefore, the control data supply circuit 305 can transmit and receive various signals to and from the ejection modules 301 and 302 and the circulation modules 303 and 304 via the group selection signal line 306 and the time-division selection signal line 307.

Specifically, each of the group selection signal line 306, the time-division selection signal line 307, and the enable signal line HE is connected to input sides of the ejection logic circuits AND1 and AND2. An output side of the ejection logic circuit AND1 and the ejection driving element MD1 are connected to each other. An output side of the ejection logic circuit AND2 and the ejection driving element MD2 are connected to each other. Therefore, the ejection driving element MD1 becomes a conduction state according to the output of the ejection logic circuit AND1, and selective control is performed such that the current flows to the ejection heater RhA. Likewise, the ejection driving element MD2 becomes the conduction state according to the output of the ejection logic circuit AND1, and selective control is performed such that the current flows to the ejection heater RhA. Additionally, the circulation driving element MD3 becomes the conduction state according to the output of the circulation logic circuit AND3, and selective control is performed such that the current flows to the circulation heater RhB. Likewise, the circulation driving element MD4 becomes the conduction state according to the output of the circulation logic circuit AND4, and selective control is performed such that the current flows to the circulation heater RhB.

Note that, although it is not illustrated, the control data supply circuit 305 includes a shift register and a latch circuit. In the shift register, serial data transfer of a time-division selection signal is performed according to the clock signal. The latch circuit holds the time-division selection signal according to the latch signal.

### First Case

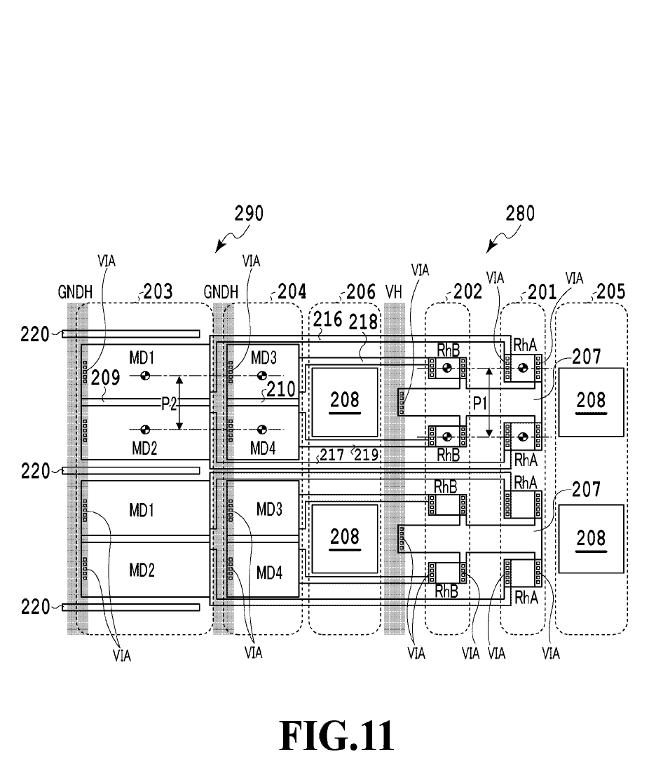

FIG. 11 is a diagram illustrating an arrangement example of the heater and the driving element in a first case according to the present embodiment. In FIG. 11, as the heater, the ejection heater RhA and the circulation heater RhB are arranged in the printing element substrate 300. Additionally, in FIG. 11, as the driving element, the ejection driving elements MD1 and MD2 and the circulation driving elements MD3 and MD4 are arranged in the printing element substrate 300. Moreover, in FIG. 11, drain wirings 216, 217, 218, and 219 are arranged in the printing element substrate 300. Note that, in the following description, it is assumed that each of the ejection driving elements MD1 and MD2 is formed of a Metal-Oxide-Semiconductor Field Effect Transistor (MOSFET). Additionally, in the following description, it is assumed that each of the circulation driving elements MD3 and MD4 is formed of the MOSFET (Metal-Oxide-Semiconductor Field Effect Transistor). It should be noted that each of the ejection driving elements MD1 and MD2 and the circulation driving elements MD3 and MD4 may be formed of an element other than the MOSFET. For example, each of the ejection driving elements MD1 and MD2 and the circulation driving elements MD3 and MD4 may be formed of a bipolar transistor. Alternatively, each of the ejection driving elements MD1 and MD2 and the circulation driving elements MD3 and MD4 may be formed of an Insulated Gate Bipolar Transistor (IGBT).

Specifically, in the example in FIG. 11, supply port rows 205 and 206, an ejection heater row 201, a circulation heater row 202, an ejection driving element row 203, and a circulation driving element row 204 are arranged in the printing element substrate 300. In the present embodiment, the ejection heater row 201 is arranged in parallel on a left side of the supply port row 205. The circulation heater row 202 is arranged in parallel on a left side of the ejection heater row 201. The supply port row 206 is arranged in parallel on a left side of the circulation heater row 202. The circulation driving element row 204 is arranged in parallel on a left side of the supply port row 206. The ejection driving element row 203 is arranged in parallel on a left side of the circulation driving element row 204. A via VIA is provided between the circulation heater row 202 and the supply port row 206. The via VIA between the circulation heater row 202 and the supply port row 206 is electrically connected with the power source line VH on another wiring layer. The via VIA is provided between the circulation driving element row 204 and the ejection driving element row 203. The via VIA between the circulation driving element row 204 and the ejection driving element row 203 is electrically connected with the ground line GNDH on the other wiring layer. The via VIA is provided on a left side of the ejection driving element row 203. The via VIA on the left side of the ejection driving element row 203 is electrically connected with the ground line GNDH on the other wiring layer.

In the present embodiment, a case where the current of the circulation heater RhB is smaller than the current of the ejection heater RhA is assumed. In the example in FIG. 11, an element area in a row width direction of the circulation driving elements MD3 and MD4 is smaller than that of the ejection driving elements MD1 and MD2. Here, it is assumed that the row width direction is a traverse direction within the same row of the traverse direction orthogonal to a row length (also referred to as longitudinal) direction of the row formed of multiple elements as the target arrayed in one row.

In the ejection heater row 201, multiple ejection heaters RhA are arranged in one row. An array density of the ejection heaters RhA is 600 dpi, for example. In the circulation heater row 202, multiple circulation heaters RhB are arranged in one row. The circulation heaters RhB are arranged adjacent to the ejection heaters RhA in pairs, respectively. In the ejection driving element row 203, multiple units in which the ejection driving element MD1 and the ejection driving element MD2 are arranged adjacent to each other in a row direction are arranged. In each unit, a shared ground electrode 209 is arranged as a shared electrode between the ejection driving element MD1 and the ejection driving element MD2 adjacent to the ejection driving element MD1. The shared ground electrode 209 is electrically connected with the ground line GNDH on the other wiring layer through the via VIA. In the circulation driving element row 204, multiple units in which the circulation driving element MD3 and the circulation driving element MD4 are arranged adjacent to each other in the row direction are arranged. In each unit, a shared ground electrode 210 as the shared electrode is arranged between the circulation driving element MD3 and the circulation driving element MD4 adjacent to the circulation driving element MD3. As with the shared ground electrode 209, the shared ground electrode 210 is electrically connected with the ground line GNDH on the other wiring layer through the via VIA.

A distance P2 between the centers of gravity of the ejection driving element MD1 and the ejection driving element MD2 for the respective units is smaller than a distance P1 between the centers of gravity of the ejection heaters RhA. The distance P2 between the centers of gravity of the ejection driving element MD1 and the ejection driving element MD2 for the respective units is smaller than the distance P1 between the centers of gravity of the circulation heaters RhB. For example, in a case where the ejection heaters RhA are arrayed at 600 dpi, the distance P1 is 42.3 μm. On the other hand, for each unit, the distance P2 is about 32 μm while including the shared ground electrode 209. Therefore, there is an excess space of about 10 μm. With utilization of the excess space, it is possible to arrange a substrate contact 220 between the units of the ejection driving element MD1 and the ejection driving element MD2. Additionally, with utilization of the excess space, it is also possible to route the drain wirings 216 and 217 between the units of the circulation driving element MD3 and the circulation driving element MD4. Here, the center of gravity means the center of an element region including also an extraction unit of the electrode required for driving. Specifically, the center of gravity is an intersection point of the center between one end and another end of the element in the row length direction and the center between one end and another end of the element in the row width direction.

The ejection heater RhA and the circulation heater RhB are connected to a power source wiring 207. In the example in FIG. 11, two ejection heaters RhA and two circulation heaters RhB are connected to one power source wiring 207. That is, four heaters are connected to the common power source wiring 207. The power source wiring 207 is connected to the power source line VH on the other wiring layer through the via VIA. Note that, in a case where a current density is allowable and a case where a power source wiring resistance is allowable, eight heaters or 16 heaters may be connected to the common power source wiring 207.

Note that, although the circulation heater RhB is used for circulation in the present embodiment, a heater with a smaller driving current than the driving current of the ejection heater RhA may be applied. Also in this case, the area in the row width direction of the driving element to drive the heater (since this is not for circulation, the element is not identified as the element for circulation) is smaller than the area of the ejection driving elements MD1 and MD2 in the row width direction. Additionally, although the supply port row 206 is provided in FIG. 11, no supply port row 206 may be applied. Moreover, although independent supply ports 208 are arranged as the supply port row 205 in FIG. 11, one elongated supply port that is not independent may be arranged. Furthermore, in FIG. 11, an example in which the position of the center of gravity of the circulation driving element MD3 is on a hypothetical extension line, which is from the center of gravity position of the ejection driving element MD1 along the row width direction orthogonal to the row length direction of the ejection driving element row 203, and is on the same layer as that of the ejection driving elements MD1 and MD2 is illustrated. Likewise, in FIG. 11, an example in which the position of the center of gravity of the circulation driving element MD4 is on the hypothetical extension line, which is from the center of gravity position of the ejection driving element MD2 along the row width direction orthogonal to the row length direction of the ejection driving element row 203, and is on the same layer as that of the ejection driving elements MD1 and MD2 is illustrated. That is, in a coordinate system in which the hypothetical extension line in the row length direction is the longitudinal axial direction, and the hypothetical extension line in the row width direction is the traverse axial direction, the center of gravity position of the ejection driving element MD1 and the center of gravity position of the circulation driving element MD3 are on the same coordinate in the row width direction. Likewise, in the coordinate system in which the hypothetical extension line in the row length direction is the longitudinal axial direction, and the hypothetical extension line in the row width direction is the traverse axial direction, the center of gravity position of the ejection driving element MD2 and the center of gravity position of the circulation driving element MD4 are on the same coordinate in the row width direction. Note that, in FIG. 11, an example in which the center of gravity position of the ejection driving element MD1 and the center of gravity position of the circulation driving element MD3 are on the same coordinate in the row width direction, and the center of gravity position of the ejection driving element MD2 and the center of gravity position of the circulation driving element MD4 are on the same coordinate in the row width direction is described. That is, although an example in which the center of gravity position of the ejection driving element MD1 and the center of gravity position of the circulation driving element MD3 are on the same hypothetical extension line, and the center of gravity position of the ejection driving element MD2 and the center of gravity position of the circulation driving element MD4 are on the same hypothetical line is described, it is not limited to this example. A distance between the centers of gravity of the ejection driving element MD1 and the ejection driving element MD2 may be greater than a distance between the centers of gravity of the circulation driving element MD3 and the circulation driving element MD4. Even in the above-described arrangement configuration, it is possible to route the drain wirings 216 and 217 between the units of the circulation driving element MD3 and the circulation driving element MD4.

### Second Case

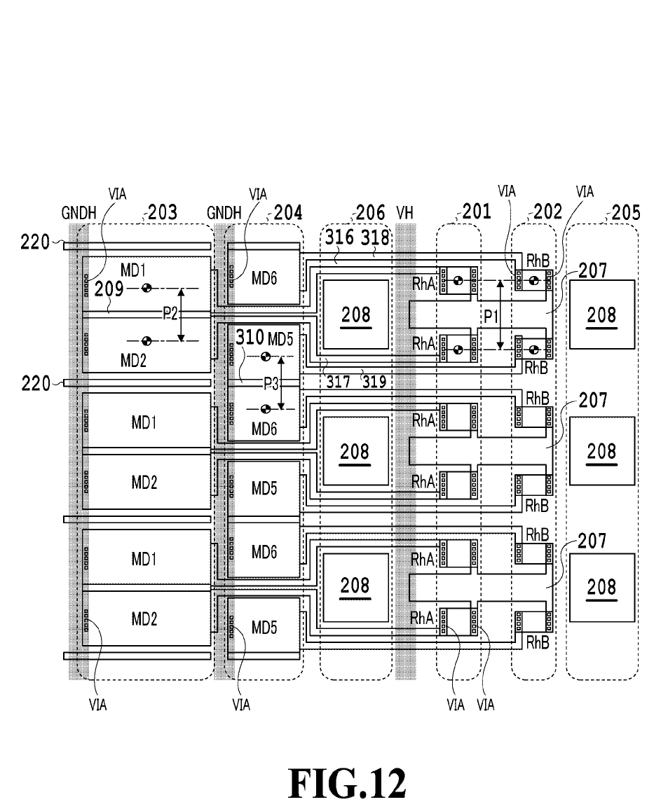

FIG. 12 is a diagram illustrating an arrangement example of the heater and the driving element in a second case according to the present embodiment. In FIG. 12, as the heater, the ejection heater RhA and the circulation heater RhB are arranged in the printing element substrate 300. Additionally, in FIG. 12, as the driving element, the ejection driving elements MD1 and MD2 and circulation driving elements MD5 and MD6 are arranged in the printing element substrate 300. Additionally, in FIG. 12, drain wirings 316, 317, 318, and 319 are arranged in the printing element substrate 300. A different point from the first case is that the positional relationship between the ejection heater row 201 and the circulation heater row 202 is the opposite. That is, the ejection heater row 201 is arranged on a driving element region side, which includes the ejection driving elements MD1 and MD2 and the circulation driving elements MD5 and MD6, with respect to the circulation heater row 202. Therefore, the arrangement of the driving element is also different from the first case.

Specifically, the unit of the circulation driving elements MD5 and MD6 is arranged to be displaced from the unit of the ejection driving element MD1 and the ejection driving element MD2 by a half pitch in the row length direction. That is, in FIG. 12, an example in which the center of gravity position of the circulation driving element MD5 is not on the hypothetical extension line, which is from the center of gravity position of the ejection driving element MD1 along the row width direction orthogonal to the row length direction of the ejection driving element row 203, and is not on the same layer as that of the ejection driving elements MD1 and MD2 is illustrated. Likewise, in FIG. 12, an example in which the center of gravity position of the circulation driving element MD6 is not on the hypothetical extension line, which is from the center of gravity position of the ejection driving element MD2 along the row width direction orthogonal to the row length direction of the ejection driving element row 203, and is not on the same layer as that of the ejection driving elements MD1 and MD2 is illustrated. In other words, in the coordinate system in which the hypothetical extension line in the row length direction is the longitudinal axial direction, and the hypothetical extension line in the row width direction is the traverse axial direction, the center of gravity position of the ejection driving element MD1 and the center of gravity position of the circulation driving element MD5 are not on the same coordinate in the row width direction. Likewise, in the coordinate system in which the hypothetical extension line in the row length direction is the longitudinal axial direction, and the hypothetical extension line in the row width direction is the traverse axial direction, the center of gravity position of the ejection driving element MD2 and the center of gravity position of the circulation driving element MD6 are not on the same coordinate in the row width direction. In this case, assuming that a position within the unit is a reference position, and one pitch is defined as a distance interval to the same reference position of adjacent units. The half pitch is half of the one pitch. Therefore, with the displacement by the half pitch, even in the arrangement in which the drain wirings 318 and 319 of the circulation driving elements MD5 and MD6 are electrically connected to the circulation heater RhB, it is possible to apply the following configuration. That is, it is possible to connect the drain wirings 316 and 317 of the ejection driving element MD1 and the ejection driving element MD2 to the ejection heater RhA on the one wiring layer by routing the drain wirings 316 and 317 between the units of the circulation driving elements MD5 and MD6.

Note that, it has been known that it is more preferable to arrange the substrate contacts 220 homogeneously in a wider region with respect to the arrangement of the ejection driving element row 203 and a circulation driving element row 204 to suppress malfunction such as latch-up. Therefore, in a case where the positional relationship between the ejection heater row 201 and the circulation heater row 202 is the opposite of the first case, a configuration in which the positional relationship between the ejection driving element row 203 and the circulation driving element row 204 is also the opposite may be considered. However, in the second case, since it is possible to arrange the wider substrate contact 220 in the row width direction between the units of the ejection driving element MD1 and the ejection driving element MD2, the ejection driving element row 203 is arranged on a left side of the circulation driving element row 304.

### Third Case

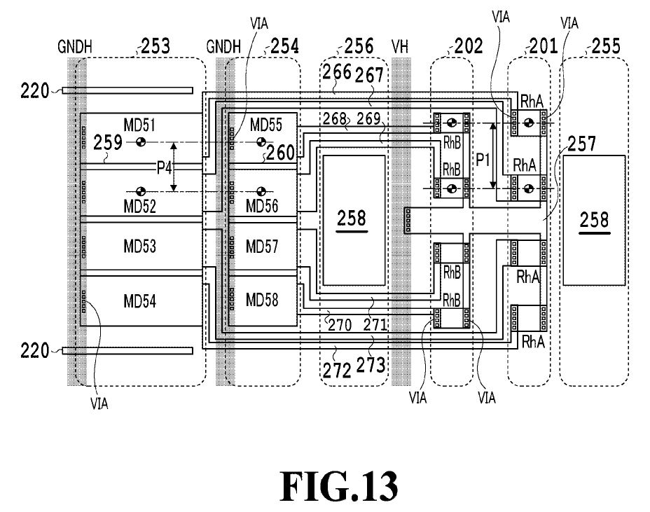

FIG. 13 is a diagram illustrating an arrangement example of the heater and the driving element in a third case according to the present embodiment. In FIG. 13, as the heater, the ejection heater RhA and the circulation heater RhB are arranged in the printing element substrate 300. Additionally, in FIG. 13, as the driving element, ejection driving elements MD51, MD52, MD53, and MD54 and circulation driving elements MD55, MD56, MD57, and MD58 are arranged in the printing element substrate 300. Moreover, in FIG. 13, drain wirings 266, 267, 268, 269, 270, 271, 272, and 273 are arranged in the printing element substrate 300. A different point from the first and second cases is that, one unit is formed of adjacent four driving elements in the third case, comparing with the first and second cases in which one unit is formed of two adjacent driving elements. Although the number of the driving elements in the unit is different from the first and second cases, it is the same that a distance P4 between the centers of gravity of the ejection driving elements MD51 and MD52 in the unit is smaller than the distance P1 between the centers of gravity of the ejection heater RhA and the circulation heater RhB. Therefore, with utilization of an excess space generated by providing shared ground electrodes 259 and 260 in the unit, it is possible to provide the substrate contact 220 between the units in an ejection driving element row 253. Additionally, with utilization of the excess space, it is possible to route the drain wirings 266, 267, 272, and 273 between the units in a circulation driving element row 254.

Note that, an array pitch is different between the supply port 208 in the first case and a supply port 258 in the third case. In a case where the array pitch is wide like the supply port 258, a configuration in which one unit is formed of four driving elements or one unit is formed of four or more driving elements to improve the efficiency of wiring such as the drain wiring 266. With this configuration, it is possible to share the electrode in a boundary portion between the units, and thus it is possible to suppress enlargement of the driving element region.

### Fourth Case

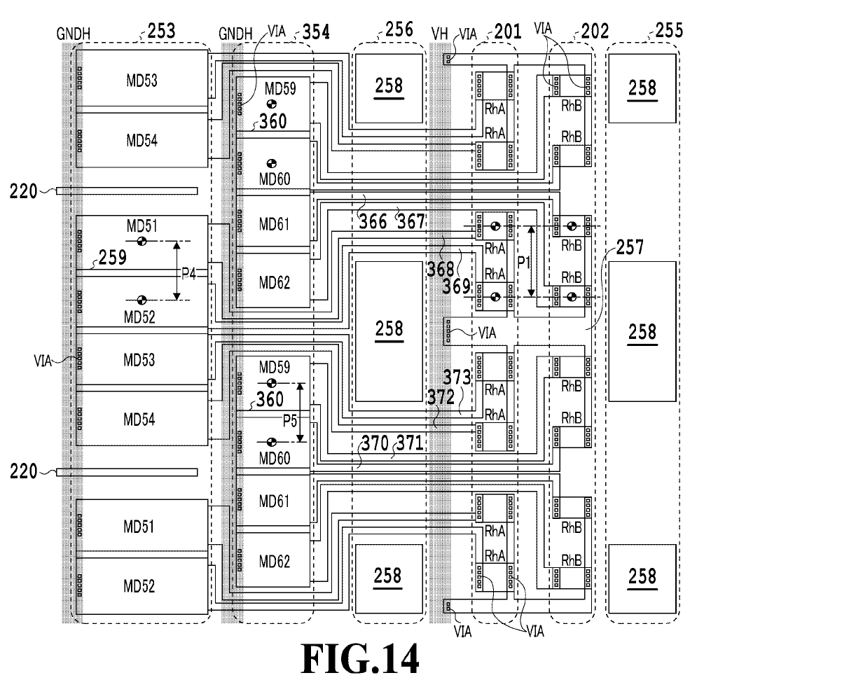

FIG. 14 is a diagram illustrating an arrangement example of the heater and the driving element in a fourth case according to the present embodiment. In FIG. 14, as the heater, the ejection heater RhA and the circulation heater RhB are arranged in the printing element substrate 300. Additionally, in FIG. 14, as the driving element, the ejection driving elements MD51, MD52, MD53, and MD54 and circulation driving elements MD59, MD60, MD61, and MD62 are arranged in the printing element substrate 300. Moreover, in FIG. 13, drain wirings 366, 367, 368, 369, 370, 371, 372, and 373 are arranged in the printing element substrate 300. A different point from the third case is that the positional relationship between the ejection heater row 201 and the circulation heater row 202 in the row width direction is the opposite. Therefore, as with the second case, a configuration in which the unit in a circulation driving element row 354 is displaced from the unit in the ejection driving element row 253 by the half pitch in the row length direction. Additionally, as with the third case, since the array pitch of the supply port 258 is wide, one unit is formed of four or more driving elements. Thus, it is possible to share the electrode in the boundary portion between the units, and thus it is possible to suppress enlargement of the driving element region.

### First Comparative Example

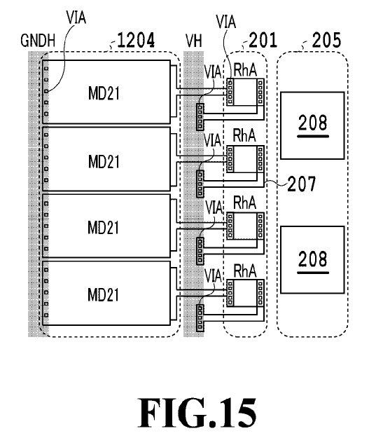

FIG. 15 is a diagram illustrating an arrangement example of the heater and the driving element in a first comparative example. In FIG. 15, an example in which the ejection heater RhA is arranged but the circulation heater RhB is not arranged is illustrated. The ejection heaters RhA are arranged at the array density of 600 dpi to form the ejection heater row 201. An ejection driving elements MD21 are arranged at an array density of 600 dpi that is equal to the array density of the ejection heaters RhA and form an ejection driving element row 1204. The ejection driving element row 1204 is arranged in parallel to the ejection heater row 201.

### Second Comparative Example

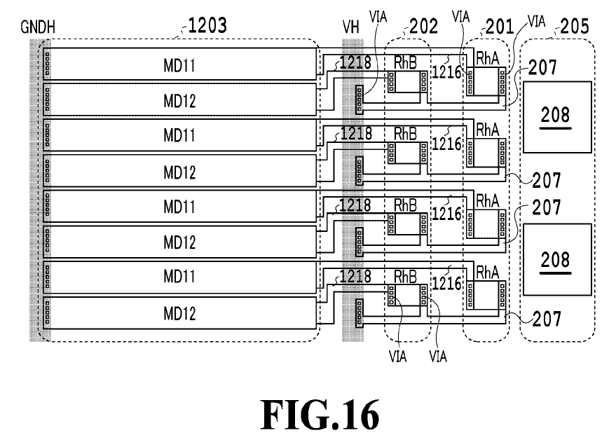

FIG. 16 is a diagram illustrating an arrangement example of the heater and the driving element in a second comparative example. The ejection heaters RhA are arranged at the array density of 600 dpi to form the ejection heater row 201. The circulation heaters RhB are arranged at the same array density as that of the ejection heater RhA and form the circulation heater row 202. The ejection heater RhA is electrically connected with an ejection driving element MD11 via a wiring layer 1216. The circulation heater RhB is electrically connected with a circulation driving element MD12 via a wiring layer 1218. In a case of forming the printing element substrate 300 by a more inexpensive manufacturing process, it is not preferable to further provide the electric connection wiring layer as another layer in addition to the conductive layer extracting each electrode of the ejection driving element MD11 and the circulation driving element MD12. That is, it is preferable to form the conductive layer in the ejection driving element MD11 and the circulation driving element MD12 and the wiring layers 1216 and 1218 on the same layer and form in the same manufacturing step. In the example in FIG. 16, a driving element row 1203 in which multiple units each including the ejection driving element MD11 and the circulation driving element MD12 are arranged is formed. In the driving element row 1203, the driving elements are arranged at 1200 dpi that is an array density twice the array density of the ejection heaters RhA. With the above-described arrangement configuration, it is possible to wire the wiring layer 1216 on the same layer as the wiring layer 1218. However, comparing with the first comparative example, in the second comparative example, twice the number of driving elements are arranged in the row length direction. Therefore, a dimension of each driving element in the row length direction is half that of the first comparative example. Accordingly, in FIG. 14, an example in which the dimension in the row width direction is twice that in the second comparative example to make the driving element area the same as that in the first comparative example so as to secure the driving capability to flow the same driving current as that in the first comparative example in the ejection driving element MD11 is illustrated.

On the other hand, the driving current of the circulation heater RhB may generate the heat energy to circulate the ink in the individual flow path 23. Additionally, in a case where the driving current of the circulation heater RhB is smaller than the driving current of the ejection heater RhA, the current driving capability of the circulation driving element MD12 may be smaller than the current driving capability of the ejection driving element MD11. Therefore, it is preferable that an area of the circulation driving element MD12 is smaller than an area of the ejection driving element MD11. However, in the second comparative example, the ejection driving element MD11 and the circulation driving element MD12 are arranged in the same area. Therefore, as the printing element substrate 300, an excess element size of the circulation driving element MD12 may cause the cost increase.

### Details of Wiring Configuration; First Case

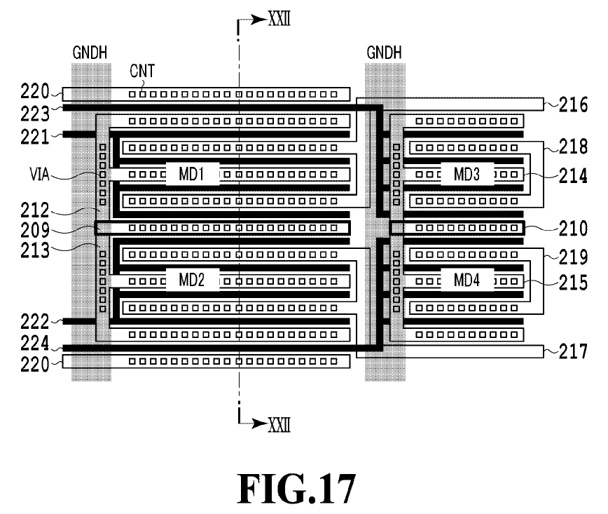

FIG. 17 is a diagram illustrating an enlarged example of the driving element in the first case. In FIG. 17, as the driving element, the ejection driving elements MD1 and MD2 and the circulation driving elements MD3 and MD4 are illustrated. In the ejection driving element MD1, a gate electrode 221, a source electrode 212, and a drain electrode 216 are provided. In the ejection driving element MD2, a gate electrode 222, a source electrode 213, and a drain electrode 217 are provided. The source electrode 212 and the source electrode 213 are at the same electric potential. Additionally, the source electrode 212 and the source electrode 213 partially share and use the electrode in the shared ground electrode 209 and are connected with the ground line GNDH on the other wiring layer through the via VIA. In other words, the source electrode 212 and the source electrode 213 are electrically connected to each other in the shared ground electrode 209 that is a shared region. Since the shared ground electrode 209 as the shared region is electrically connected with the ground line, the ejection driving elements MD1 and MD2 are at a stable reference potential. Note that, although the drain electrode 216 and the drain wiring 216 are denoted by the same reference numeral, they are at the same electric potential, and in the present embodiment, the terms are used differently depending on whether the viewpoint is the electrode or the wiring. The same applies to the drain electrode 217 and the drain wiring 217.

In the circulation driving element MD3, a gate electrode 223, a source electrode 214, and a drain electrode 218 are provided. In the circulation driving element MD4, a gate electrode 224, a source electrode 215, and a drain electrode 219 are provided. The source electrode 214 and the source electrode 215 are at the same electric potential. Additionally, the source electrode 214 and the source electrode 215 partially share and use the electrode in the shared ground electrode 210 and are connected with the ground line GNDH on the other wiring layer through the via VIA. In other words, the source electrode 214 and source electrode 215 is electrically connected to each other in the shared ground electrode 210 that is the shared region. Since the shared ground electrode 210 as the shared region is electrically connected with the ground line GNDH, the circulation driving elements MD3 and MD4 are at a stable reference potential. Note that, the gate electrode 223 is electrically connected by being routed between the units of the ejection driving elements MD1 and MD2. Likewise, the gate electrode 224 is electrically connected by being routed between the units of the ejection driving elements MD1 and MD2.

### Details of Wiring Configuration; Another Configuration of First Case

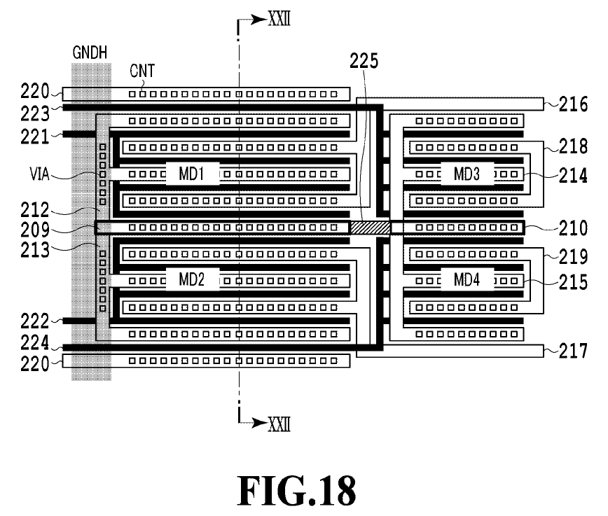

FIG. 18 is a diagram illustrating an enlarged example of the driving element with fewer ground lines than that in FIG. 17. For example, in a case where the current flowing in the circulation driving elements MD3 and MD4 is smaller than the current flowing in the circulation driving elements MD3 and MD4 in FIG. 17, the shared ground electrode 210 may be electrically connected with the shared ground electrode 209 via a wiring 225.

### Details of Wiring Configuration; Second Case

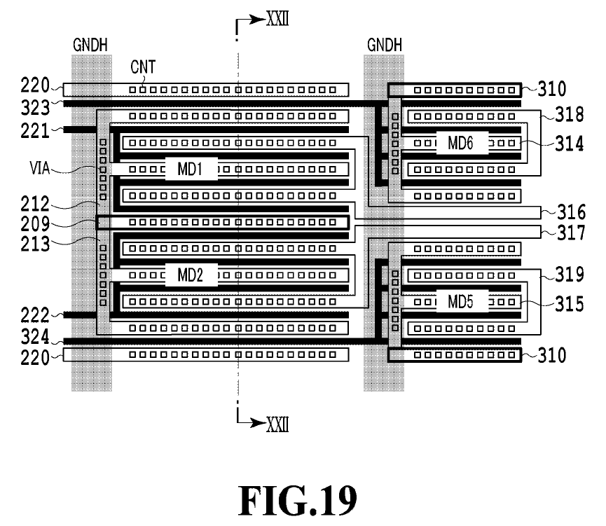

FIG. 19 is a diagram illustrating an enlarged example of the driving element in a second case. In FIG. 19, as the driving element, the ejection driving elements MD1 and MD2 and the circulation driving elements MD5 and MD6 are illustrated. In the ejection driving element MD1, the gate electrode 221, the source electrode 212, and a drain electrode 316 are provided. In the ejection driving element MD2, the gate electrode 222, the source electrode 213, and a drain electrode 317 are provided. The source electrode 212 and the source electrode 213 are at the same electric potential. Additionally, the source electrode 212 and the source electrode 213 partially share and use the electrode in the shared ground electrode 209 and are connected with the ground line GNDH on the other wiring layer through the via VIA. Note that, although the drain electrode 316 and the drain wiring 316 are denoted by the same reference numeral, they are at the same electric potential, and in the present embodiment, the terms are used differently depending on whether the viewpoint is the electrode or the wiring. The same applies to the drain electrode 317 and the drain wiring 317.

In the circulation driving element MD6, a gate electrode 323, a source electrode 314, and a drain electrode 318 are provided. In the circulation driving element MD5, a gate electrode 324, a source electrode 315, and a drain electrode 319 are provided. The source electrode 314 and the source electrode 315 are at the same electric potential. Additionally, in FIG. 19, since the source electrode 314 and the source electrode 315 are in different units, no electrode is shared. Therefore, since an excess space is generated between the units, the drain wirings 316 and 317 are routed. Additionally, in the same unit, a shared ground electrode 310 is provided. Note that, the gate electrode 323 is electrically connected by being routed between the units of the ejection driving elements MD1 and MD2. Likewise, the gate electrode 324 is electrically connected by being routed between the units of the ejection driving elements MD1 and MD2.

### Details of Wiring Configuration; Another Configuration of Second Case

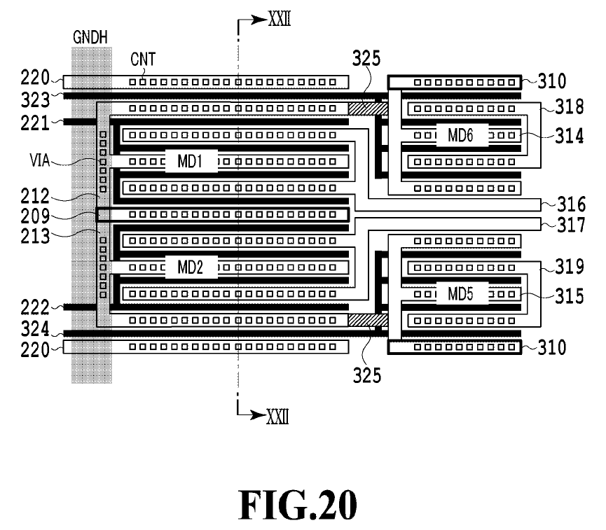

FIG. 20 is a diagram illustrating an enlarged example of the driving element with fewer ground lines than that in FIG. 19. For example, in a case where the current flowing in the circulation driving elements MD5 and MD6 is smaller than the current flowing in the circulation driving elements MD5 and MD6 in FIG. 19, the shared ground electrode 310 may be electrically connected with the shared ground electrode 209 via a wiring 325.

### Details of Wiring Configuration; Second Comparative Example

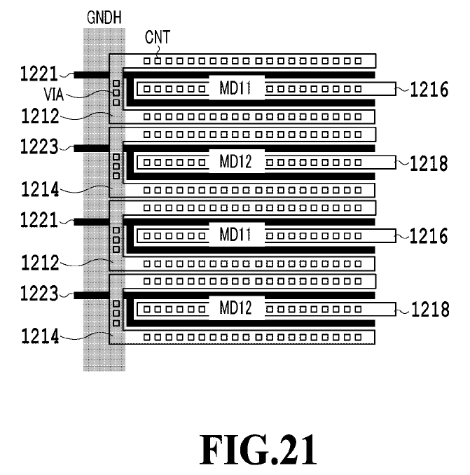

FIG. 21 is a diagram illustrating an enlarged example of the driving element in the second comparative example. The ejection driving element MD11 and the circulation driving element MD12 are formed of a repeated pattern of source electrodes 1212 and 1214 and drain electrodes 1216 and 1218 in the row length direction. Therefore, there is less room for flexible reduction of only the area of the circulation driving element MD12 in the row length direction. On the other hand, there is room for flexible reduction of the area of the circulation driving element MD12 in the row width direction. Specifically, there is room for flexible reduction of the source electrode 1214, the drain electrode 1218, and a gate electrode 1223. However, a region that is generated by the reduction in the row width direction does not contribute to the downsizing of the printing element substrate 300. Note that, although the wiring layer 1216 and the drain electrode 1216 are denoted by the same reference numeral, they are both electrically connected and at the same potential and are used differently depending on whether the viewpoint such as routing of wiring and the extraction unit of the electrode of the driving element.

### Details of Wiring Configuration; Cross Section Structure

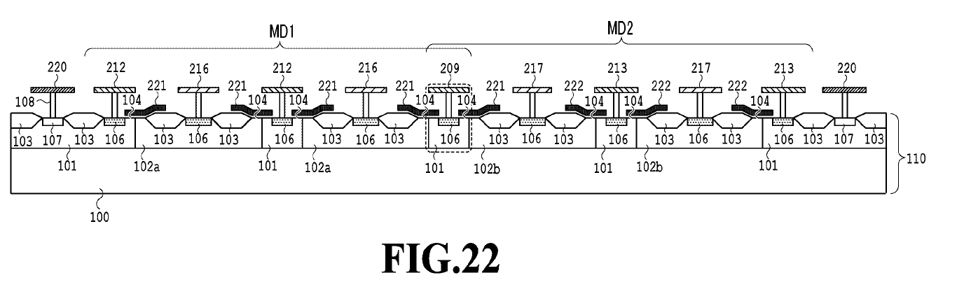

FIG. 22 is a diagram illustrating a cross section structure taken along a XXII-XXII line in FIGS. 17-20. As illustrated in FIG. 22, in a semiconductor substrate 110, a P-well region 101 and N-well regions 102a and 102b are formed on a P-type silicon substrate 100. An impurity concentration of the N-well regions 102a and 102b with respect to the P-type silicon substrate 100 is a concentration that makes a breakdown voltage of the N-well regions 102a and 102b and the P-type silicon substrate 100 higher than the voltage applied to the power source line VH.

The impurity concentration of the P-well region 101 and the N-well regions 102a and 102b is a concentration that makes the breakdown voltage of the P-well region 101 and the N-well regions 102a and 102b higher than the voltage applied to the power source line VH. In the P-well region 101 and the N-well regions 102a and 102b, a field oxide film 103, a high concentration N-type diffusion region 106, and a high concentration P-type diffusion region 107 are formed. For example, it is possible to form the field oxide film 103 by a Local Oxidation of Silicon (LOCOS) method.

### Configuration of Ejection Driving Elements MD1 and MD2

A configuration of the ejection driving elements MD1 and MD2 is described. In FIG. 19, an example in which the ejection driving elements MD1 and MD2 are each formed of a high-voltage-proof NMOS transistor is illustrated. The gate electrodes 221 and 222 are arranged on the adjacent P-well region 101 and N-well regions 102a and 102b via a gate insulation film 104. A region in which the P-well region 101 and the gate electrodes 221 and 222 overlap is a channel formation region.

The high concentration N-type diffusion region 106 is a source electrode of the ejection driving elements MD1 and MD2. The high concentration P-type diffusion region 107 is a back-gate electrode of the ejection driving elements MD1 and MD2. The back-gate electrode of the ejection driving elements MD1 and MD2 is at the same potential as the substrate contact 220 of the ejection driving elements MD1 and MD2. The substrate contact 220 is connected with the ground line GNDH via the wiring layer. Therefore, the high concentration P-type diffusion region 107 is electrically connected with the ground line GNDH, and the reference potential is determined. The N-well regions 102a and 102b each include a portion extending to a portion below each of the gate electrodes 221 and 222 as an electric field reduction region of the drain electrode. The high concentration N-type diffusion region 106 formed in the N-well regions 102a and 102b is a drain electrode of the ejection driving elements MD1 and MD2. In addition, a drain side of the gate electrodes 221 and 222 has a structure of mounting on the field oxide film 103 formed in the N-well regions 102a and 102b, which is a so-called LOCOS offset structure. Thus, it is possible to secure a gate -drain voltage proof even in a case where the ejection driving elements MD1 and MD2 are in an OFF state, that is, the voltage of the gate electrode is GND, and the voltage of the drain electrode rises to the voltage applied to the power source line VH.

It is possible to form the gate insulation film 104 in a manufacturing step of the semiconductor substrate 110. For example, it is possible to form the gate insulation film 104 from an oxide film. Additionally, the gate electrodes 221 and 222 may be a polysilicon layer, for example. It is possible to form the polysilicon layer, the high concentration N-type diffusion region 106, and the high concentration P-type diffusion region 107 in the same step as a step of forming each element of the ejection driving elements MD1 and MD2 forming a low-voltage-proof logic circuit.

On the high concentration P-type diffusion region 107, the high concentration N-type diffusion region 106, and the field oxide film 103, an insulation film in which multiple contact units 108 are provided is provided. On the insulation film, conductive layers 212, 213, 216, 217, and 220 are provided. It is possible to form each of the conductive layers 212, 213, 216, 217, and 220 from a metal such as aluminum, for example. Note that, as long as the conductive layer, each electrode, and the wiring are electrically connected, a manufacturing method, material, and a structure thereof are not limited. Note that, although the conductive layer 212 and the source electrode 212 are denoted by the same reference numeral, they are both electrically connected and at the same potential and are used differently depending on whether the viewpoint of a function such as the cross section structure and the extraction unit of the electrode from the driving element. The same applies to the conductive layer 213 and the source electrode 213. The same applies to the wiring 216, the conductive layer 216, and the drain electrode 216. The same applies to the drain wiring 217, the conductive layer 217, and the drain electrode 217. The same applies to the drain wiring 218 and the drain electrode 218. The same applies to the drain wiring 219 and the drain electrode 219. The same applies to the conductive layer 220 and the substrate contact 220. The same applies to the conductive layer 221 and the gate electrode 221.

Here, the source electrode of the ejection driving elements MD1 and MD2 shares the P-well region 101, the high concentration N-type diffusion region 106, the contact unit 108, and the conductive layer 221 via the shared ground electrode 209. In a case where the ejection driving element MD1 is in an ON state, an ON potential is applied to the gate electrode 221, and the current flows from the conductive layer 216 on a drain electrode side to the shared ground electrode 209. On the other hand, in a case where the ejection driving element MD2 is in an ON state, the ON potential is applied to the gate electrode 222, and the current flows from the conductive layer 217 on a drain current side to the shared ground electrode 209. In the present embodiment, although an example of the cross section of the ejection driving elements MD1 and MD2 is described, the circulation driving elements MD3 and MD4 have a similar cross section structure and include the shared ground electrode 210. In a case of the cross section structure of the circulation driving elements MD3 and MD4, unlike the illustration in FIG. 19, the substrate contacts 220 are not arranged on two sides, and the drain wirings 216 and 217 to the ejection driving elements MD1 and MD2 are arranged on the two sides.

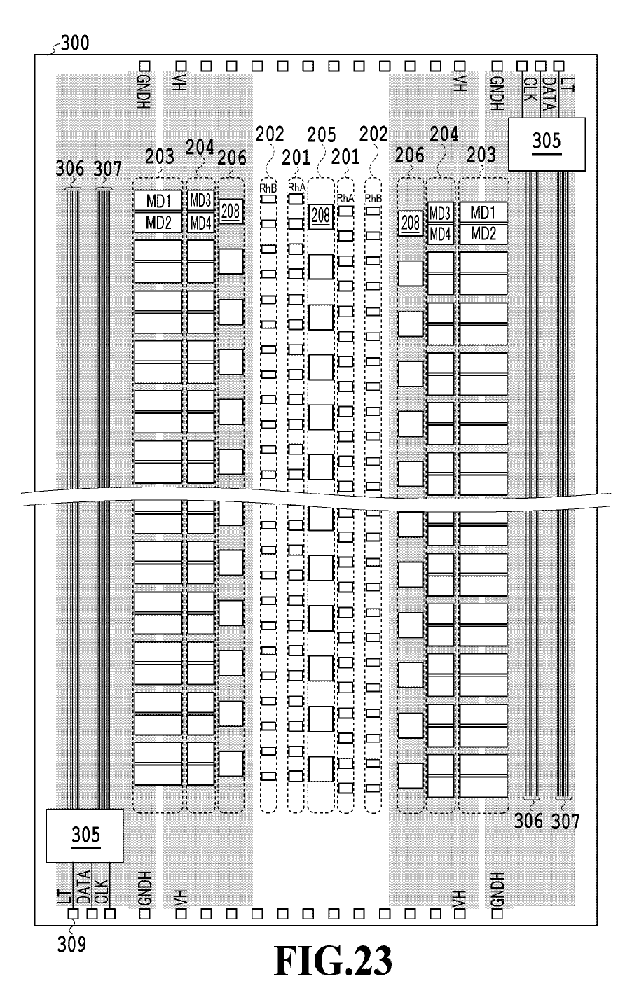

Note that, although an example in which the shared ground electrodes 209 and 210 are provided while the source electrodes of the ejection driving elements MD1 and MD2 and the circulation driving elements MD3 and MD4 are at the same potential is described in the present embodiment, it is not particularly limited thereto. For example, a configuration in which the drain electrode sides of the ejection driving elements MD1 and MD2 and the circulation driving elements MD3 and MD4 are connected commonly with the power source line VH, and each source electrode side is connected to the ejection heater RhA and the circulation heater RhB may be applied. Next, another circuit configuration example of the printing element substrate 300 according to the present embodiment is described with reference to FIG. 23.

### Another Circuit Configuration Example

FIG. 23 is a diagram illustrating the other circuit configuration example of the printing element substrate according to the present embodiment. In FIG. 23, an example in which the configuration in FIG. 11 is arranged in two rows, point-symmetrically with respect to the center of the printing element substrate 300, is illustrated. The group selection signal line 306 and the time-division selection signal line 307 are arranged in parallel to the ejection driving element row 203. Although the control data supply circuit 305 is arranged close to an external connection terminal row 309, the control data supply circuit 305 may be arranged in parallel to the group selection signal line 306 along the row length direction. Although the two rows of the ejection heater rows 201 arranged on the right and left of the centered printing element substrate 300 are arranged such that the coordinates in the row direction are displaced by the half pitch from the heater pitch, the coordinates in the row length direction may coincide with each other.

Although descriptions are provided above while illustrating various examples and embodiments of the present disclosure, the intent and the scope of the present disclosure are not limited to a specific description in the present specification. The present disclosure is not limited to the above-described embodiments, and various modifications may be applied. Additionally, the present disclosure may be an appropriate combination of a part of the above-described embodiments.

### Modification 1

For example, although an example of using the via VIA for the electric connection with the other wiring layer is described in the present embodiment, it is not particularly limited thereto. For example, instead of the via VIA that allows the electric conduction between the one wiring layer and the other wiring layer of the multiple laminated wiring layers, a through-hole that allows the electric conduction between all the wiring layers may be used.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, it is possible to properly arrange a driving element in a printing element substrate.

This application claims the benefit of Japanese Patent Application No. 2025-064371, filed Apr. 9, 2025 which is hereby incorporated by reference herein in its entirety.

What is claimed is:

1. A printing element substrate, comprising:
a first heating resistance element row including a plurality of first heating resistance elements, out of a plurality of heating resistance elements, being arranged in one row;
a second heating resistance element row including a plurality of second heating resistance elements, out of the plurality of heating resistance elements, being arranged in one row in parallel to the first heating resistance element row, the plurality of second heating resistance elements being different from the plurality of first heating resistance elements;
a first driving element row including a plurality of first driving elements, out of a plurality of driving elements, being arranged in one row in order to drive the plurality of first heating resistance elements, the plurality of driving elements being arranged in order to drive the plurality of heating resistance elements; and
a second driving element row including a plurality of second driving elements, out of the plurality of driving elements, being arranged in one row in order to drive the plurality of second heating resistance elements, in parallel to the first driving element row, the plurality of second driving elements being different from the plurality of the first driving elements, wherein
a distance between centers of gravity of the two adjacent first driving elements, which are out of the respective plurality of first driving elements, is smaller than a distance between centers of gravity of the two adjacent first heating resistance elements, which are out of the respective plurality of first heating resistance elements, and a distance between the centers of gravity of the two adjacent second driving elements, which are out of the respective plurality of second driving elements, is smaller than a distance between the centers of gravity of the two adjacent second heating resistance elements, which are out of the respective plurality of second heating resistance elements.

2. The printing element substrate according to claim 1, wherein
the first heating resistance element generates energy to eject a liquid in a liquid ejection head as an ejection heater, and
the second heating resistance element generates energy to circulate the liquid in the liquid ejection head as a circulation heater.

3. The printing element substrate according to claim 2, further comprising:
a plurality of first driving units formed of the two or more adjacent first driving elements, which are out of the respective plurality of first driving elements;
a plurality of second driving units formed of the two or more adjacent second driving elements, which are out of the respective plurality of second driving elements; and
a plurality of first wirings configured to electrically connect the plurality of first driving units and the plurality of first heating resistance elements, wherein
the plurality of heating resistance elements are arranged on one side of a row width direction orthogonal to a row length direction of the second driving element row with respect to a position at which the second driving unit is arranged,
the first driving unit is arranged on another side of the row width direction orthogonal to the row length direction of the second driving element row with respect to the position at which the second driving unit is arranged, and
the plurality of first wirings are formed to be routed between the plurality of second driving units.

4. The printing element substrate according to claim 3, further comprising:
a plurality of second wirings configured to electrically connect the plurality of second driving units and the plurality of second heating resistance elements, wherein
the second wiring is formed on the same layer as a layer of the first wiring.

5. The printing element substrate according to claim 3, wherein
in the two first driving elements in the first driving unit, source electrodes on a side on which the two first driving elements are adjacent to each other are electrically connected to each other in a shared region, and
the shared region is electrically connected with a ground line.

6. The printing element substrate according to claim 3, wherein
in the two second driving elements in the second driving unit, source electrodes on a side on which the two second driving elements are adjacent to each other are electrically connected to each other in a shared region, and
the shared region is electrically connected with a ground line.

7. The printing element substrate according to claim 2, wherein
an element area of the first driving element is greater than an element area of the second driving element.

8. The printing element substrate according to claim 2, wherein
a driving current of the first heating resistance element is greater than a driving current of the second heating resistance element.

9. The printing element substrate according to claim 3, wherein
a gate electrode of the second driving element is electrically connected by being routed between the first driving units.

10. The printing element substrate according to claim 1, wherein
a position of the center of gravity of the second driving element is on a hypothetical extension line, which is from a position of the center of gravity of the first driving element along a row width direction orthogonal to a row length direction of the first driving element row.

11. The printing element substrate according to claim 1, wherein
a position of the center of gravity of the second driving element is not on a hypothetical extension line, which is from a position of the center of gravity of the first driving element along a row width direction orthogonal to a row length direction of the first driving element row.

12. The printing element substrate according to claim 5, wherein
the ground line is included in a ground wiring layer provided on a layer different from a layer on which the source electrode of the first driving element is formed and is electrically connected with the source electrode through a via.

13. The printing element substrate according to claim 6, wherein
the ground line is included in a ground wiring layer provided on a layer different from a layer on which the source electrode of the second driving element is formed and is electrically connected with the source electrode through a via.

14. The printing element substrate according to claim 4, further comprising:
a first supply port row including a plurality of first supply ports being arranged in one row in order to supply an ink; and
a second supply port row including a plurality of second supply ports being arranged in one row in order to supply an ink, in parallel to the first supply port row, wherein
the first heating resistance element row and the second heating resistance element row are arranged between the first supply port row and the second supply port row, and
the second supply port row is arranged in parallel to and closer to the second driving element row than the first driving element row.

15. The printing element substrate according to claim 14, wherein
the first wiring and the second wiring are arranged to be routed between the respective second supply ports.

16. The printing element substrate according to claim 4, wherein
the first driving element, the second driving element, the first wiring, and the second wiring are formed in the same semiconductor manufacturing step.
